(19) United States
(12) Patent Application Publication
(10) Pub. No.: US 2026/0248192 A1
(43) Pub. Date: Aug. 27, 2026

(54) AEROSOL GENERATING DEVICE

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 18/577,981

(22) PCT Filed: Jul. 20, 2022
(86) PCT No.: PCT/KR2022/010611

§ 371 Date: Jan. 9, 2024

(30) Foreign Application Priority Data
Jul. 21, 2021 (KR) 10-2021-0095836
Jul. 21, 2021 (KR) 10-2021-0095837
Aug. 25, 2021 (KR) 10-2021-0112580

(51) Int. Cl. A24F 40/465; A24F 40/51; A24F 40/70

(52) U.S. Cl. CPC A24F 40/465; A24F 40/51; A24F 40/70

(57) ABSTRACT

An aerosol-generating device is disclosed. The aerosol-generating device of the disclosure includes a pipe; a first plate partitioning an inside of the pipe to define an insertion space; an elongated heater extending through the first plate such that one side of the heater is disposed in the insertion space and an opposite side of the heater is disposed in a sealing space positioned opposite the insertion space with respect to the first plate; and a sealing member charged in the sealing space.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to provide an aerosol-generating device having a structure for sealing gaps formed around a heater.

It is still another object of the present disclosure to prevent thermal deformation of a structure near the heater.

It is still another object of the present disclosure to stably fix the heater and the structure near the heater and to prevent rotation of the heater.

It is still another object of the present disclosure to prevent disconnection or twisting of lead wires for applying power to the heater.

It is still another object of the present disclosure to provide an aerosol-generating device in which a structure for coupling components around the heater is simplified.

### Solution to Problem

In accordance with an aspect of the present disclosure for accomplishing the above objects, there is provided an aerosol-generating device including a pipe; a first plate partitioning an inside of the pipe to define an insertion space; an elongated heater extending through the first plate such that one side of the heater is disposed in the insertion space and an opposite side of the heater is disposed in a sealing space positioned opposite the insertion space with respect to the first plate; and a sealing member charged in the sealing space.

### Advantageous Effects of Invention

According to at least one of embodiments of the present disclosure, an aerosol-generating device having a structure for sealing gaps formed around a heater may be provided.

According to at least one of embodiments of the present disclosure, thermal deformation of a structure near the heater may be prevented.

According to at least one of embodiments of the present disclosure, the heater and the structure near the heater may be stably fixed, and rotation of the heater may be prevented.

According to at least one of embodiments of the present disclosure, twisting or disconnection of lead wires for applying power to the heater may be prevented.

According to at least one of embodiments of the present disclosure, an aerosol-generating device in which a structure for coupling components around the heater is simplified may be provided.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 49 are views showing examples of an aerosol-generating device according to embodiments of the present disclosure.

### MODE FOR THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

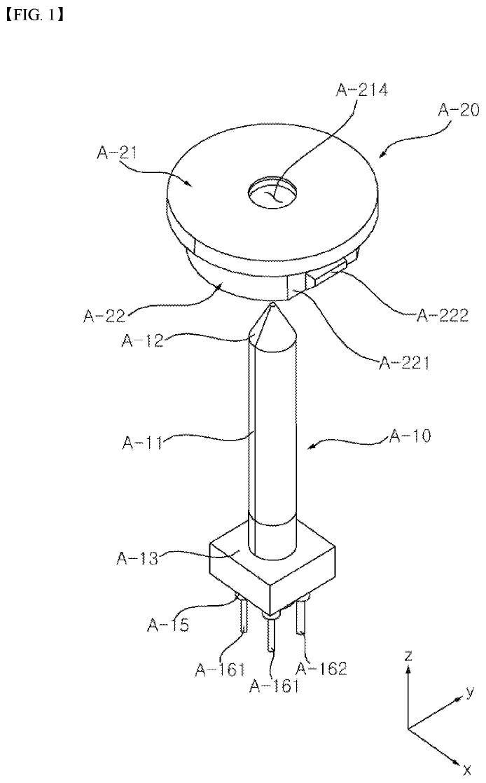

Referring to FIG. 1, a heater A-10 may be formed to be elongated in one direction. The heater A-10 may have a cylindrical shape. The heater A-10 may be pointed at one end. The heater A-10 may be heated by directly receiving power, or may be heated by an induction-heating method using an induction coil disposed near the heater.

The heater A-10 may include a heater body A-11. The heater body A-11 may be elongated in the upward-downward direction. The heater body A-11 may have a cylindrical shape. The heater A-10 may include a heater tip A-12. The heater tip A-12 may be formed at one end of the heater A-10. The heater tip A-12 may be connected to the upper end of the heater body A-11. The heater tip A-12 may have a shape that is gradually narrowed in the upward direction. The heater tip A-12 may be pointed at one end. The heater A-10 may pierce a cigarette.

The heater A-10 may include a flange A-13. The flange A-13 may be coupled to a portion of the heater body A-11, or may be integrally formed with the heater body A-11. The flange A-13 may be formed adjacent to the lower end of the heater body A-11. The heater body A-11 may have a shape that penetrates the center of the flange A-13. The flange A-13 may have a non-circular shape. For example, the flange A-13 may have a rectangular shape.

A first cover A-20 may include a first plate A-21 and a first peripheral portion A-22. The first plate A-21 may form the upper portion of the first cover A-20. A heater insertion hole A-214 may be formed in such a manner that the center of the first plate A-21 is open. The first plate A-21 may have a flat shape. The first plate A-21 may also be referred to as a partition A-21.

The first peripheral portion A-22 may extend downwards from the first plate A-21. The first peripheral portion A-22 may be integrally formed on the lower surface of the first plate A-21. The first peripheral portion A-22 may be recessed further inwards than the outer circumferential surface of the first plate A-21. A portion of the outer circumferential surface of the first peripheral portion A-22 may be formed to be flat so as to form a first flat portion A-221. A hook A-222 may be formed to protrude from a portion of the outer circumferential surface of the first peripheral portion A-22 or from the first flat portion A-221.

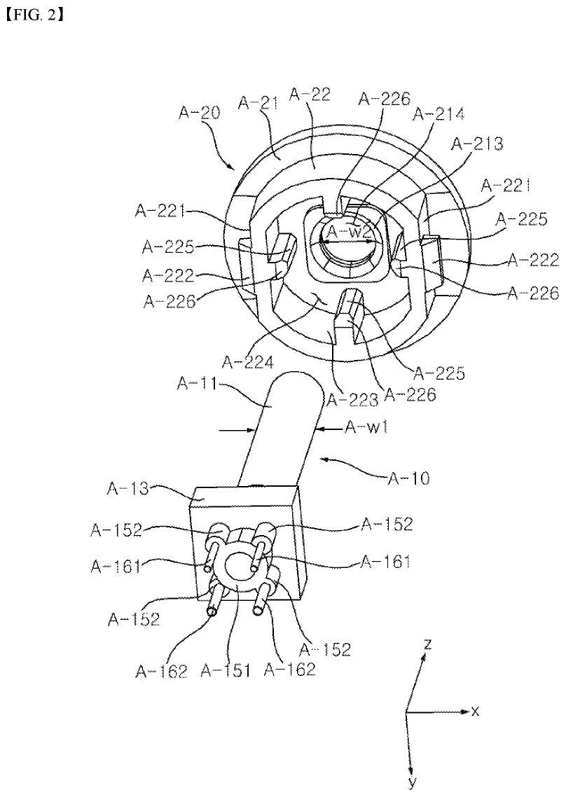

Referring to FIG. 2, a first lead wire A-161 may be exposed downwards from a portion peripheral to the lower end portion A-151 of the heater A-10. The first lead wire A-161 may penetrate a fixing portion A-152. The first lead wire A-161 may be electrically connected to the heater A-10 to transmit power to the heater A-10. The heater A-10 may generate heat using the power received from the first lead wire A-161. The first lead wire A-161 may be provided in a pair.

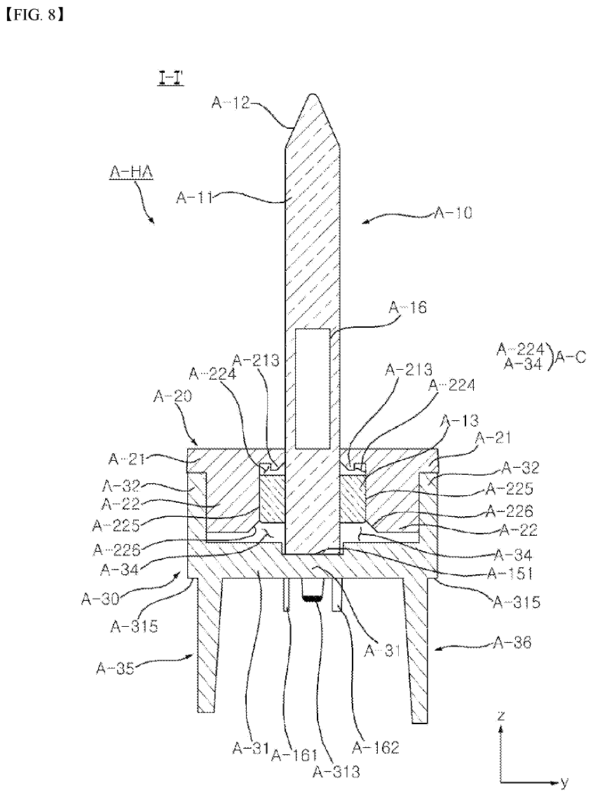

A second lead wire A-162 may be exposed downwards from a portion peripheral to the lower end portion A-151 of the heater A-10. The second lead wire A-162 may penetrate the fixing portion A-152. The heater A-10 may be formed to be hollow. A sensor A-16 (refer to FIG. 8) may be mounted inside the heater A-10. The sensor A-16 may sense the temperature of the heater A-10. The second lead wire A-162 may be electrically connected to the sensor A-16 to transmit power to the sensor A-16. The second lead wire A-162 may be provided in a pair. The first lead wire A-161 and the second lead wire A-162 may be disposed opposite each other with respect to the lower end portion A-151. The first lead wire A-161 and the second lead wire A-162 may have mutually different thicknesses.

The fixing portion A-152 may be formed on the periphery of the lower end portion A-151 of the heater A-10. The fixing portion A-152 may protrude in the radially outward direction from the outer circumferential surface of the lower end portion A-151 of the heater A-10. The fixing portion A-152 and the lower end portion A-151 may be disposed beneath the flange A-13. The fixing portion A-152 may be provided in a plural number, and the plurality of fixing portions A-152 may be arranged in the circumferential direction along the outer circumferential surface of the lower end portion A-151. One of the fixing portions A-152 may surround and fix the first lead wire A-161. The other of the fixing portions A-152 may surround and fix the second lead wire A-162. The number of fixing portions A-152 may correspond to the number of first and second lead wires A-161 and A-162. For example, when two first lead wires A-161 and two second lead wires A-162 are provided, the number of fixing portions A-152 may be four.

A first space A-224 may be located under the first plate A-21, and may communicate with a heater insertion hole A-214. The first plate A-21 may cover the upper side of the first space A-224. The inner circumferential surface A-223 of the first peripheral portion A-22 may surround the side portion of the first space A-224. The first space A-224 may be open downwards.

The heater insertion hole A-214 may be formed in such a manner that a portion of the first plate A-21 is open. The heater insertion hole A-214 may communicate with the first space A-224. The heater insertion hole A-214 may be located above the first space A-224. The heater insertion hole A-214 may be spaced apart from the first peripheral portion A-22. The heater insertion hole A-214 may have a circular shape. The heater insertion hole A-214 may have a shape corresponding to the cross-sectional shape of the heater body A-11.

A port portion A-213 may be formed around the heater insertion hole A-214, and may protrude downwards from the first plate A-21. The port portion A-213 may surround the lower end of the heater insertion hole A-214. The port portion A-213 may be formed to be inclined upwards toward the heater insertion hole A-214.

A support bar A-225 may protrude from the inner circumferential surface A-223 of the first peripheral portion A-22 toward the first space A-224. The support bar A-225 may have a shape that is elongated in the upward-downward direction. The support bar A-225 may be spaced apart from the heater insertion hole A-214. The support bar A-225 may be provided in a plural number, and the plurality of support bars A-225 may be arranged so as to be spaced apart from each other in the circumferential direction along the inner circumferential surface A-223 of the first peripheral portion A-22. For example, at least one pair of support bars A-225 may be provided, and the support bars A-225 forming each pair may be disposed opposite each other with respect to the first space A-224.

A support guide A-226 may be formed at the lower end portion of the support bar A-225 so as to be inclined. The support guide A-226 may be inclined upwards from the lower end of the support bar A-225 toward the first space A-224.

The hook A-222 may be formed to protrude outwards from the first flat portion A-221. The hook A-222 may have a shape that is gradually narrowed from the upper side thereof to the lower side thereof. The hook A-222 may have a surface that is inclined outwards from the lower end of the first peripheral portion A-22 toward the upper side of the hook A-222. The hook A-222 may be formed in a plural number. A pair of hooks A-222 may be formed on two opposite sides of the first peripheral portion A-22. The pair of hooks A-222 may be formed at positions opposite each other with respect to the first space A-224.

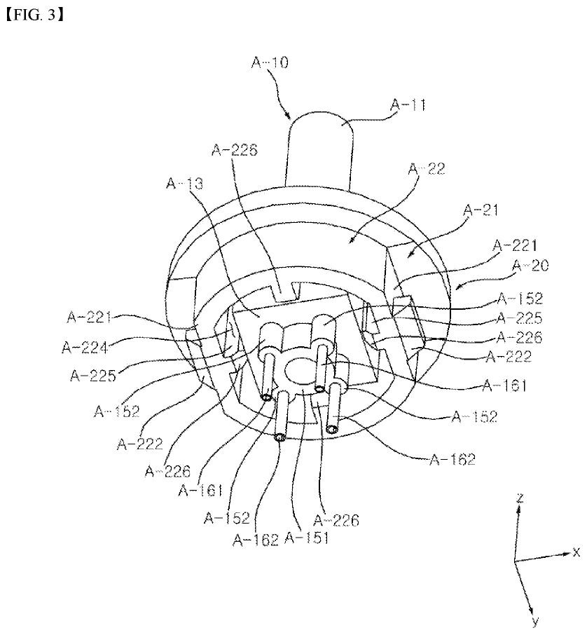

Referring to FIGS. 2 and 3, the heater A-10 may be inserted into the heater insertion hole A-214. The heater A-10 may pass through the heater insertion hole A-214 sequentially from the heater tip A-12 (refer to FIG. 1) to the heater body A-11. The width A-w1 of the heater body A-11 may be equal to or slightly greater than the width A-w2 of the heater insertion hole A-214. The heater A-10 may be tightly press-fitted into the heater insertion hole A-214. The port portion A-213 may guide the heater A-10 to the heater insertion hole A-214. The heater A-10 may come into contact with the port portion A-213, and may slide into the heater insertion hole A-214. The heater body A-11 and the heater tip A-12 (refer to FIG. 1) may be exposed upwards from the first cover A-20.

When the heater A-10 is inserted into the heater insertion hole A-214, the flange A-13 may be caught by the first plate A-21. The flange A-13 may be disposed in the first space A-224. When the heater A-10 passes through the heater insertion hole A-214, the flange A-13 may slide while contacting the support guides A-226, and may be guided into the first space A-224. The support bars A-225 may support the side portion of the flange A-13 disposed in the first space A-224. The support bars A-225 and the support guides A-226 may be arranged along the side portion of the flange A-13. Each of the plurality of support bars A-225 may support a respective one of the plurality of surfaces of the flange A-13. The support bars A-225 may separate the heater body A-11 and the flange A-13 from the first peripheral portion A-22, thereby forming a gap inside the first space A-224.

Accordingly, the heater A-10 may be easily inserted into the first cover A-20. In addition, the heater A-10 and the flange A-13 may be fixed in position without shaking or rotating in the first space A-224.

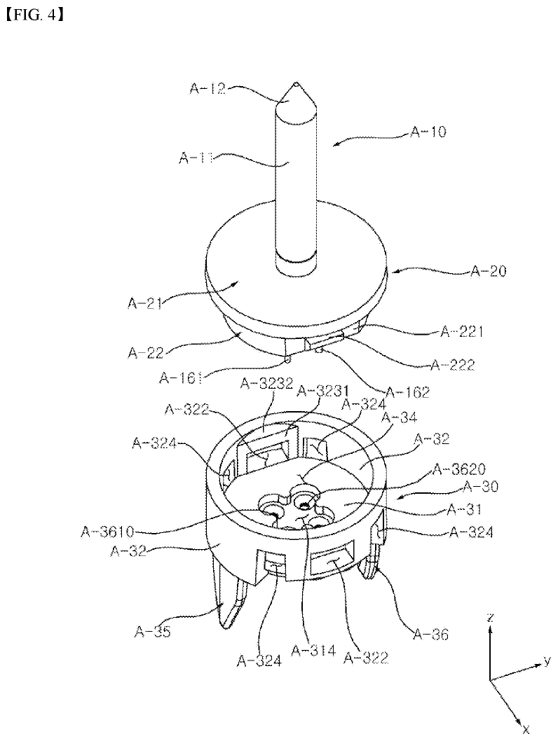

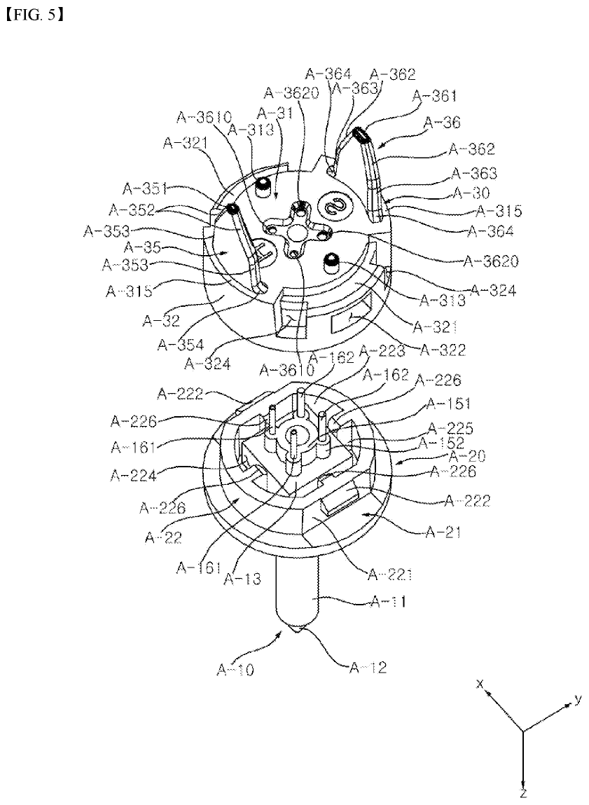

Referring to FIGS. 4 and 5, a second cover A-30 may include a second plate A-31 and a second peripheral portion A-32. The second plate A-31 may form the lower portion or the bottom of the second cover A-30. The second plate A-31 may have a flat shape. The second plate A-31 may have a disk shape.

The second peripheral portion A-32 may extend upwards from the edge of the second plate A-31. The second peripheral portion A-32 may be integrally formed with the first plate A-31. The first plate A-31 may cover the bottom of a second space A-34. The inner circumferential surface of the second peripheral portion A-32 may surround the side portion of the second space A-34. The second space A-34 may be open upwards. The second peripheral portion A-32 may be formed to be larger than the first peripheral portion A-22.

A recessed portion A-314 may be formed in such a manner that a portion of the second plate A-31 is recessed downwards. The recessed portion A-314 may be formed in a shape corresponding to the lower end portion A-151 and the fixing portion A-152 of the heater A-10. The lower end portion A-151 and the fixing portion A-152 of the heater A-10 may be inserted into and seated in the recessed portion A-314.

Cover wire holes A-3610 and A-3620 may be formed in such a manner that some portions of the second plate A-31 inside the recessed portion A-314 are open. The cover wire holes A-3610 and A-3620 may communicate with the second space A-34. The first cover wire hole A-3610 may be formed at a position corresponding to the first lead wire A-161. The first lead wire A-161 may pass through the first cover wire hole A-3610. The second cover wire hole A-3620 may be formed at a position corresponding to the second lead wire A-162. The second lead wire A-162 may pass through the second cover wire hole A-3620. The first cover wire hole A-3610 and the second cover wire hole A-3620 may have mutually different diameters.

A hook hole A-322 may be formed in such a manner that a portion of the second peripheral portion A-32 is open. The hook hole A-322 may be formed at a position corresponding to the hook A-222. The hook hole A-322 may be formed in a plural number. A pair of hook holes A-322 may be formed in two opposite sides of the second peripheral portion A-32. The pair of hook holes A-322 may be disposed at positions opposite each other with respect to the second space A-34. The hook holes A-322 may communicate with the second space A-34.

A second flat portion A-3231 and a hook guide portion A-3232 may be formed on the inner circumferential surface of the second peripheral portion A-32 at a position around the hook hole A-322. The hook guide portion A-3232 may be formed above the hook hole A-322. The hook guide portion A-3232 may be formed to be inclined from the upper side thereof to the lower side thereof toward the second space A-34. The hook guide portion A-3232 may be contiguous with the second flat portion A-3231. The second flat portion A-3231 may surround the hook hole A-322.

An inlet hole A-324 may be formed in such a manner that a portion of the second peripheral portion A-32 is open. The inlet hole A-324 may be formed near the hook hole A-322. The inlet hole A-324 may communicate with the second space A-34.

Positioning protrusions A-35 and A-36 may protrude downwards from the lower portion of the second plate A-31. Each of the positioning protrusions A-35 and A-36 may have a shape that is gradually narrowed toward the lower side thereof. The first positioning protrusion A-35 and the second positioning protrusion A-36 may have mutually different shapes. The first positioning protrusion A-35 and the second positioning protrusion A-36 may be disposed at positions opposite each other. The first positioning protrusion A-35 and the second positioning protrusion A-36 may face each other.

A positioning pin A-313 may protrude downwards from the lower portion of the second plate A-31. The positioning pin A-313 may be provided in a plural number. Each of the positioning pins A-313 may be formed in the shape of a cylinder that is rounded at one end.

Referring to FIGS. 4 to 6, the first cover A-20 and the second cover A-30 may be coupled to each other. The first peripheral portion A-22 may be inserted into the second space A-34. The second peripheral portion A-32 may surround the first peripheral portion A-22 inserted into the second space A-34. The first plate A-21 may cover the upper side of the second space A-34.

When the first peripheral portion A-22 is inserted into the second space A-34, the hook A-222 is inserted into the hook hole A-322, whereby the first cover A-20 and the second cover A-30 may be engaged with each other. The hook A-222 may sequentially slide on the hook guide portion A-3232 and the second flat portion A-3231, and may be inserted into the hook hole A-322. The first flat portion A-221 may sequentially slide on the hook guide portion A-3232 and the second flat portion A-3231, and may face the second flat portion A-3231. The first flat portion A-221 may be in contact with or in close proximity to the second flat portion A-3231.

When the first cover A-20 and the second cover A-30 are coupled to each other, the first space A-224 and the second space A-34 may communicate with each other. The second space A-34 may be located below the first space A-224. The first space A-224 and the second space A-34 may include regions that overlap each other. The space in which the first space A-224 and the second space A-34 communicate with each other may be defined as a chamber A-C (refer to FIG. 8). The chamber A-C may be surrounded by the first cover A-20 and the second cover A-30. The first plate A-21 may cover the upper portion of the chamber A-C. The second plate A-31 may cover the lower portion of the chamber A-C. The first peripheral portion A-22 may cover part of the side portion of the chamber A-C. The first peripheral portion A-22 may cover only part of the side portion of the second space A-34. The chamber A-C may also be referred to as a sealing space A-C.

The inlet hole A-324, which is formed in such a manner that a portion of the second peripheral portion A-32 is open, may communicate with the chamber A-C. The chamber A-C may be exposed to the outside through the inlet hole A-324. A portion of the hook hole A-322 may communicate with the chamber A-C. The chamber A-C may be exposed to the outside through the hook hole A-322.

When the first cover A-20 and the second cover A-30 are coupled to each other, the flange A-13 may be disposed inside the chamber A-C. The lower end portion A-151 and the fixing portion A-152 of the heater A-10 may be inserted into the recessed portion A-314, and may be supported by the second plate A-31. The first lead wire A-161 may pass through the first cover wire hole A-3610, and may be exposed downwards from the second plate A-31. The second lead wire A-162 may pass through the second cover wire hole A-3620, and may be exposed downwards from the second plate A-31.

The first positioning protrusion A-35 may be spaced apart from the edge of the second plate A-31 in the inward direction to form a spaced portion A-315. The second positioning protrusion A-36 may be spaced apart from the edge of the second plate A-31 in the inward direction to form a spaced portion A-315. When the first positioning protrusion A-35 and the second positioning protrusion A-36 are inserted into a mold, a tolerance margin is secured due to the spaced portions A-315, whereby manufacturing consistency is ensured.

The first positioning protrusion A-35 may include a first tip portion A-351. The first positioning protrusion A-35 may include a first inclined portion A-352. The first positioning protrusion A-35 may include a first extension portion A-353. The first positioning protrusion A-35 may include a first rounded portion A-354.

The first tip portion A-351 may be formed at an end of the first positioning protrusion A-35. The first inclined portion A-352 may extend from the first tip portion A-351 toward the second plate A-31 so as to be inclined in the outward direction of the first tip portion A-351. The first inclined portion A-352 may be inclined so as to be gradually narrowed in the direction approaching the first tip portion A-351. The first inclined portion A-352 may be provided in a pair, and the pair of first inclined portions A-352 may extend from two opposite sides of the first tip portion A-351. The first extension portion A-353 may be bent and extend from the first inclined portion A-352 toward the second plate A-31. The first extension portion A-353 may extend in the upward-downward direction. The first rounded portion A-354 may extend from the first extension portion A-353 toward the second plate A-31 so as to be rounded outwards. The first rounded portion A-354 may be connected to the second plate A-31.

The second positioning protrusion A-36 may include a second tip portion A-361. The second positioning protrusion A-36 may include a second inclined portion A-362. The second positioning protrusion A-36 may include a second extension portion A-363. The second positioning protrusion A-36 may include a second rounded portion A-364.

The second tip portion A-361 may be formed at an end of the second positioning protrusion A-36. The second inclined portion A-362 may extend from the second tip portion A-361 toward the second plate A-31 so as to be inclined in the outward direction of the second tip portion A-361. The second inclined portion A-362 may be inclined so as to be gradually narrowed in the direction approaching the second tip portion A-361. The second inclined portion A-362 may be provided in a pair, and the pair of second inclined portions A-362 may extend from two opposite sides of the second tip portion A-361. The second extension portion A-363 may be bent and extend from the second inclined portion A-362 toward the second plate A-31. The second extension portion A-363 may extend in the upward-downward direction. The second rounded portion A-364 may extend from the second extension portion A-363 toward the second plate A-31 so as to be rounded outwards. The second rounded portion A-364 may be connected to the second plate A-31.

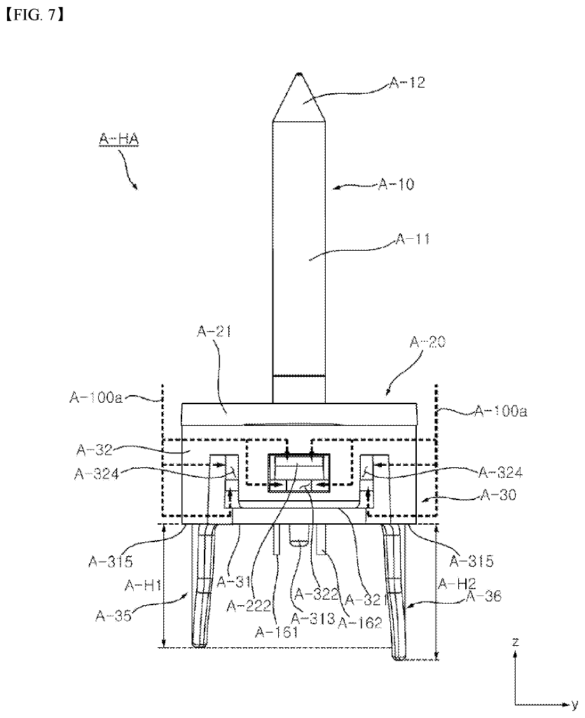

The first positioning protrusion A-35 and the second positioning protrusion A-36 may have mutually different shapes. The first positioning protrusion A-35 and the second positioning protrusion A-36 may have mutually different heights. For example, the height A-H2 of the second positioning protrusion A-36 may be greater than the height A-H1 of the first positioning protrusion A-35 (refer to FIG. 7). The first tip portion A-351 and the second tip portion A-361 may have mutually different widths or sizes. The first inclined portion A-352 and the second inclined portion A-362 may extend to different lengths. The first extension portion A-353 and the second extension portion A-363 may extend to different lengths. Alternatively, the first positioning protrusion A-35 and the second positioning protrusion A-36 may be disposed at positions that are not opposite each other or do not face each other.

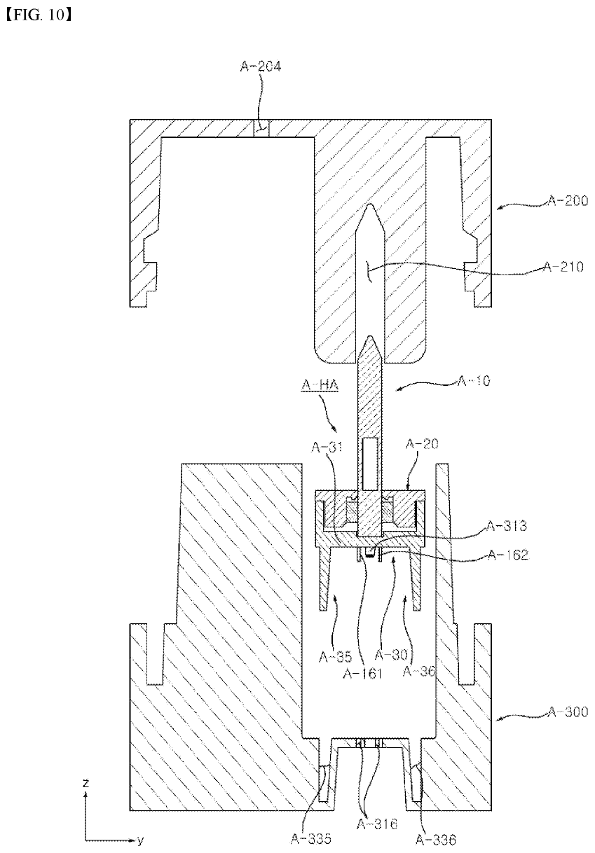

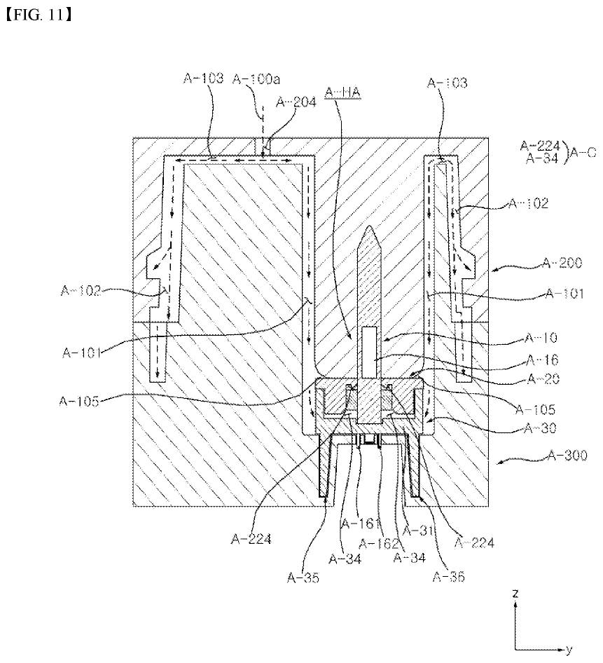

Accordingly, when the first positioning protrusion A-35 and the second positioning protrusion A-36 are inserted into recesses formed in the mold, the second cover A-30, the first cover A-20 coupled thereto, and the heater A-10 may be easily disposed at correct positions in the mold (refer to FIG. 10). In addition, the first rounded portion A-354 may reduce damage to parts in the process of injecting a molten molding material A-100a into the mold (refer to FIG. 11).

The second plate A-31 may not cover the lower side of the inlet hole A-324. The inlet hole A-324 may be open downwards. The second plate A-31 may be recessed from the part of the second peripheral portion A-32, in which the inlet hole A-324 is formed, in the radially inward direction, and thus may be spaced apart from the lower portion of the inlet hole A-324 in the radially inward direction. A lower portion A-321 of the second peripheral portion A-32, which is located between the inlet holes A-324, may also be referred to as a recess portion A-321. The recess portion A-321 may be exposed downwards because the edge of the second plate A-31 is recessed in the radially inward direction.

Accordingly, when the molten molding material A-100a is injected into the mold, the molding material may be easily introduced into the chamber A-C through the inlet hole A-324 and the hook hole A-322 (refer to FIGS. 7 and 11).

Hereinafter, the structure in which the heater A-10, the first cover A-20, and the second cover A-30 are coupled to each other will be referred to as a heater assembly A-HA.

Referring to FIG. 7, the first molding material A-100a may be introduced or injected into the covers A-20 and A-30 through the inlet hole A-324 and/or the hook hole A-322, whereby the chamber A-C may be filled with the first molding material A-100a. The first molding material A-100a, which is in a molten state, may be introduced or injected into the covers A-20 and A-30, and may then be cured inside the chamber A-C. The first molding material A-100a may fill all of the gaps formed in the coupling portions between the covers A-20 and A-30 and the heater A-10.

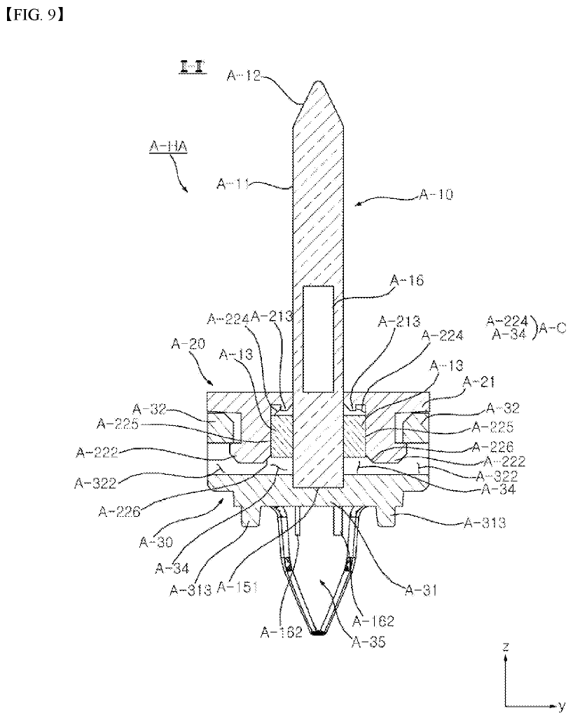

Referring to FIGS. 8 and 9, the first cover A-20 may be disposed on or coupled to the upper side of the second cover A-30. The hook A-222 may be inserted into the hook hole A-322, and thus may be caught by the second peripheral portion A-32. The hook A-222 may prevent the first cover A-20 from being separated from the second cover A-30 in the upward direction.

The first plate A-21 may cover the upper side of the second peripheral portion A-32. The first plate A-21 may be in close contact with the upper side of the second peripheral portion A-32. The first plate A-21 may cover the upper side of the chamber A-C. The first plate A-21 may be caught by the upper side of the second peripheral portion A-32, and the first peripheral portion A-22 may be inserted into the second space A-34. The first peripheral portion A-22 may be disposed inside the second peripheral portion A-32. The outer circumferential surface of the first peripheral portion A-22 may be surrounded by the second peripheral portion A-32. The lower portion of the first peripheral portion A-22 may be spaced apart from the second plate A-31 in the upward direction.

The heater body A-11 may be press-fitted into the first plate A-21 while passing through the heater insertion hole A-214 (refer to FIG. 1) in the first plate A-21. The flange A-13 may be disposed in the first space A-224. The flange A-13 may be supported or fixed by the support bar A-225. The flange A-13 may be spaced apart from the first peripheral portion A-22 by the support bar A-225. The flange A-13 may be spaced apart from the first peripheral portion A-22 and the first plate A-21, thereby forming a gap in the first space A-224. The flange A-13 may be spaced apart from the second plate A-31 in the upward direction. The lower end portion A-151 and the fixing portion A-152 of the heater A-10 may be supported or fixed by the first plate A-31.

The sensor A-16 may sense the temperature of the heater A-10. The sensor A-16 may be mounted inside the heater A-10. The heater A-10 may be formed to be hollow, and the sensor A-16 may be inserted into the heater A-10. The sensor A-16 may be formed to be elongated in one direction, and may be disposed in the longitudinal direction of the heater body A-11. The sensor A-16 may be electrically connected to the second lead wire A-162 to receive power. The heater A-10 may be electrically connected to the first lead wire A-161 to receive power.

Accordingly, the first cover A-20 and the second cover A-30 may be stably coupled to each other, and may form the chamber A-C therein. In addition, before the molding material A-100a (refer to FIG. 11) is injected into the chamber A-C, the heater A-10 may be disposed so as to be elongated upwards inside the covers A-20 and A-30 so as to prevent or minimize movement of the heater A-10. In addition, the first lead wire A-161 and the second lead wire A-162 may be prevented from contacting each other, becoming twisted with each other, or becoming disconnected.

Referring to FIGS. 10 and 11, the heater assembly A-HA may be inserted into a first mold A-200 and a second mold A-300. The upper portion of the heater assembly A-HA may be inserted into the first mold A-200. The lower portion of the heater assembly A-HA may be inserted into the second mold A-300. The first mold A-200 and the second mold A-300 may be coupled to each other in the upward-downward direction. The first mold A-200 and the second mold A-300 may be coupled to each other to form a space in which the heater assembly A-HA can be disposed.

The second mold A-300 may include mold recesses A-335 and A-336. The mold recesses A-335 and A-336 may be formed in such a manner that portions of the second mold A-300 are recessed downwards. The mold recesses A-335 and A-336 may be open upwards. The positioning protrusions A-35 and A-36 may slide in the mold recesses A-335 and A-336 to be inserted thereinto. The first positioning protrusion A-35 may be inserted into the first mold recess A-335. The second positioning protrusion A-36 may be inserted into the second mold recess A-336.

The second mold A-300 may have a mold wire hole A-316 formed therein. The mold wire hole A-316 may be formed in such a manner that a portion of the second mold A-300 is open. The mold wire hole A-316 may be formed between the first mold recess A-335 and the second mold recess A-336. The mold wire hole A-316 may be formed in a plural number. The number of mold wire holes A-316 may correspond to the number of first and second lead wires A-161 and A-162. The first lead wire A-161 and the second lead wire A-162 may pass through the mold wire holes A-316, and may be exposed outside the second mold A-300.

The first mold recess A-335 and the second mold recess A-336 may have mutually different shapes. The first mold recess A-335 may have a shape corresponding to the first positioning protrusion A-35. The second mold recess A-336 may have a shape corresponding to the second positioning protrusion A-36. The first positioning protrusion A-35 may be completely inserted into the first mold recess A-335. The first positioning protrusion A-35 may not be completely inserted into the second mold recess A-336. The second positioning protrusion A-36 may be completely inserted into the second mold recess A-336. The second positioning protrusion A-36 may not be completely inserted into the first mold recess A-335. The spaced portions A-315 may be caught or supported by the second mold A-300 at positions near the mold recesses A-335 and A-336. The positioning pin A-313 may be inserted into the hole formed in the second mold A-300, thereby guiding the heater assembly A-HA to the correct position.

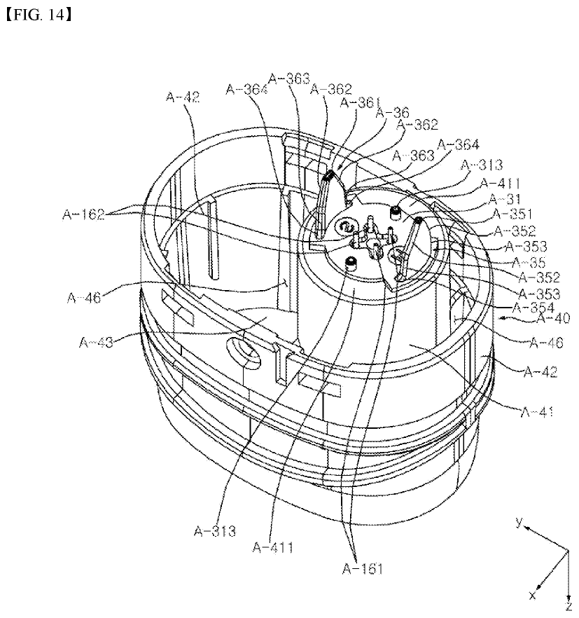

Accordingly, the heater assembly A-HA may be easily inserted into or disposed in the second mold A-200. The positions at which the first lead wire A-161 and the second lead wire A-162 are disposed relative to a housing A-40 (refer to FIG. 14) and an aerosol-generating device may be determined thereby. In addition, the first lead wire A-161 and the second lead wire A-162 may be prevented from contacting each other, becoming twisted with each other, or becoming disconnected.

The heater body A-11 may be inserted into or supported by the first mold A-200. The first mold A-200 may have a heater hole A-210 formed therein. The heater body A-11 may be inserted into or pass through the heater hole A-210. The first cover A-20 may be supported by the first mold A-200. The second cover A-30 may be supported by the second mold A-300.

When the first mold A-200 and the second mold A-300 are brought into contact with or coupled to each other, passages A-101, A-102, and A-103 may be formed between the first mold A-200 and the second mold A-300. The passages A-101, A-102, and A-103 may be connected to the heater assembly A-HA. The passages A-101, A-102, and A-103 may be connected to the chamber A-C.

The first passage A-101 may be formed between the first mold A-200 and the second mold A-300. The first passage A-101 may be formed to be elongated in the upward-downward direction. The first passage A-101 may have a cylindrical shape. The heater assembly A-HA may be disposed in the lower portion of the first passage A-101. The lower portion of the first passage A-101 may surround the side peripheral portions of the first cover A-20 and the second cover A-30.

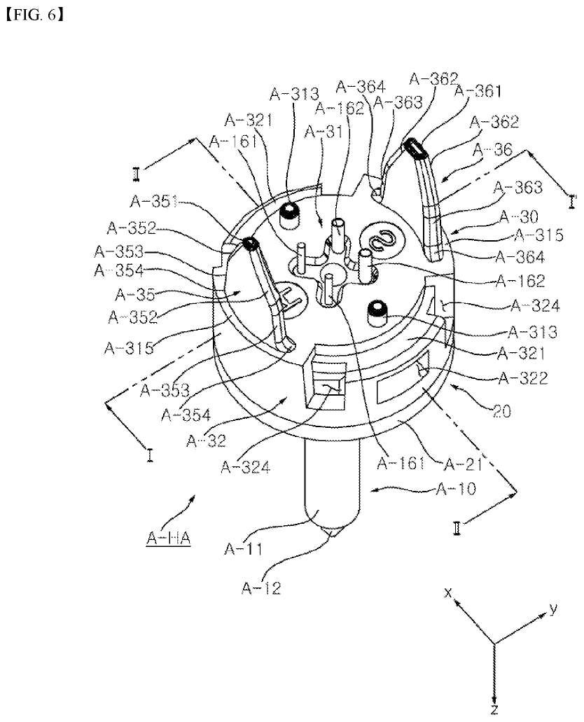

The first passage A-101 may communicate with the chamber A-C through the inlet hole A-324 (refer to FIG. 7). The first passage A-101 may communicate with the chamber A-C through the hook hole A-222 (refer to FIG. 7). The recess portion A-321 (refer to FIG. 6) may be in contact with the first passage A-101. The recess portion A-321 may be spaced apart from the second mold A-200 to form a gap.

The first passage A-101 may communicate with a latching groove A-105. The latching groove A-105 may extend along the edge of the upper end of the first cover A-20. The latching groove A-105 may extend in the circumferential direction. The latching groove A-105 may be in contact with the edge of the upper end of the first cover A-20.

The second passage A-102 may extend from the upper end of the first passage A-101 in the outward direction. The third passage A-103 may extend downwards from an end of the second passage A-102. The third passage A-103 may be spaced apart from the first passage A-101. The third passage A-103 may surround the side portion of the first passage A-101.

At least one of the first mold A-200 or the second mold A-300 may include a molding material injection hole A-204. The molding material injection hole A-204 may communicate with the passages A-101, A-102, and A-103. For example, the molding material injection hole A-204 may communicate with the second passage A-102.

The first mold A-200 and the second mold A-300 described above are merely illustrative. The disclosure is not limited to any specific number, shape, or coupling direction of molds, so long as the molds form a space in which the heater assembly A-HA can be inserted or disposed and also form the passages A-101, A-102, and A-103.

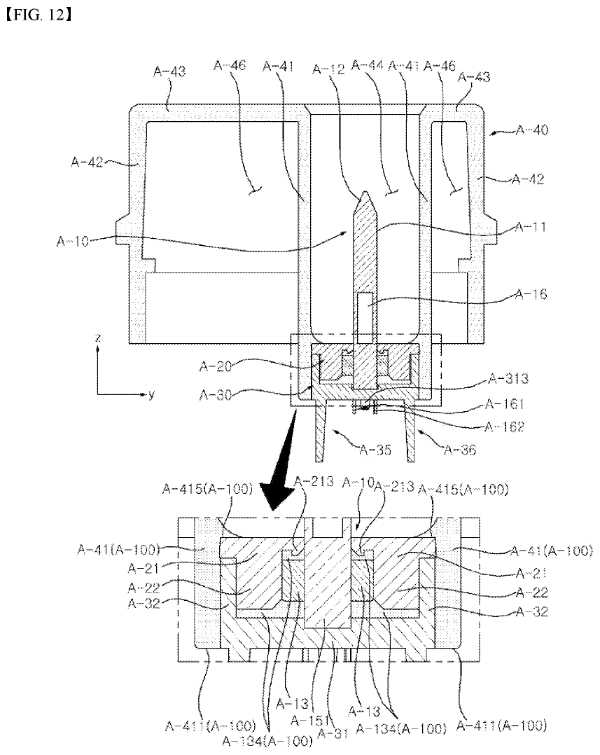

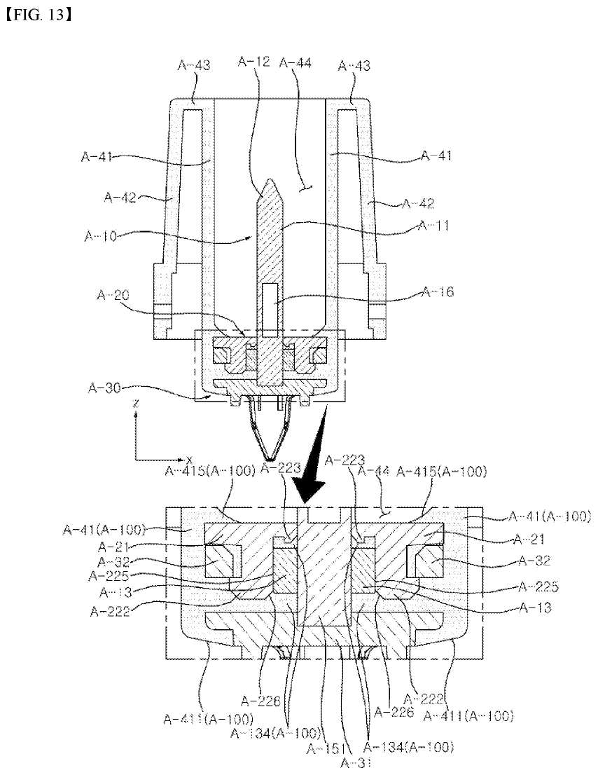

Referring to FIGS. 11 to 14, the housing A-40 may be formed through insert injection molding using the molds A-200 and A-300. A sealing member A-134 may be insert-injection-molded into the chamber A-C in the heater assembly A-HA. The sealing member A-134 may be insert-injection-molded into the gaps between the components of the heater assembly A-HA. The heater assembly A-HA and the housing A-40 may be coupled to each other through insert injection molding. The housing A-40 may be integrally connected to the sealing member A-134, which is insert-injection-molded into the heater assembly A-HA.

The first molding material A-100a may be injected into the molds A-200 and A-300 through the molding material injection hole A-204. The first molding material A-100a may be injected into the molding material injection hole A-204, and may then be introduced into the passages A-101, A-102, and A-103. The first molding material A-100a may be in a molten state. The passages A-101, A-102, and A-103 may be filled with the first molding material A-100a.

The first molding material A-100a introduced into the first passage A-101 may flow into the chamber A-C. The first molding material A-100a may be introduced into the chamber A-C from the first passage A-101 through the inlet hole A-324 (refer to FIG. 7). The first molding material A-100a may be introduced into the chamber A-C from the first passage A-101 through the hook hole A-322. The first molding material A-100a introduced into the chamber A-C may fill the gaps between the components of the heater assembly A-HA. The first molding material A-100a may be introduced into the latching groove A-105 from the first passage A-101.

The first molding material A-100a in a molten state may be cured into a second molding material A-100. After the second molding material A-100 is formed through insert injection molding, the molds may be removed, and then the positioning protrusions A-35 and A-36 may be removed.

The first molding material A-100a injected into the passages A-101, A-102, and A-103 in the molds A-200 and A-300 may be cured to form the second molding material A-100. The housing A-40 may be formed of the second molding material A-100, formed by curing the first molding material A-100a. The first molding material A-100a introduced into the chamber A-C may be cured while filling the gaps between the components of the heater assembly A-HA, thereby forming the second molding material A-100. The second molding material A-100, which is insert-injection-molded into the gaps between the components of the heater assembly A-HA in the chamber A-C and/or in the vicinity of the chamber A-C, may also be referred to as a sealing member A-134.

The sealing member A-134 may be formed of the second molding material A-100. The sealing member A-134 may be insert-injection-molded into the chamber A-C. The sealing member A-134 may fill the chamber A-C. The sealing member A-134 may be insert-injection-molded into the first space A-224. The sealing member A-134 may be insert-injection-molded into the second space A-34. The sealing member A-134 may be insert-injection-molded between the heater insertion hole A-214 (refer to FIG. 1) and the heater body A-11. The sealing member A-134 may be insert-injection-molded into the cover wire holes A-3610 and A-3620 (refer to FIG. 4). The sealing member A-134 may be insert-injection-molded into the recessed portion A-314 (refer to FIG. 4). The sealing member A-134 may be insert-injection-molded into the gap between the first cover A-20 and the second cover A-30. The flange A-13 may be surrounded and fixed by the sealing member A-134.

The housing A-40 may be formed through insert injection molding, and may be formed of the second molding material A-100. The housing A-40 may include a pipe A-41. The housing A-40 may include an outer wall A-42. The housing A-40 may include an upper wall A-43. The housing A-40 may include a latching portion A-415. The housing A-40 may include a pipe bottom A-411.

The pipe A-41 may be formed of the second molding material A-100, formed by curing the first molding material A-100a introduced into the first passage A-101. The pipe A-41 may have a cylindrical shape. The pipe A-41 may have formed therein an insertion space A-44 having two open opposite sides. The insertion space A-44 may have a cylindrical shape. The insertion space A-44 may be formed to be elongated in the upward-downward direction. The upper side of the insertion space A-44 may communicate with the outside. The lower side of the insertion space A-44 may be covered by the covers A-20 and A-30.

The pipe A-41 may be coupled to the heater assembly A-HA through insert injection molding. The heater assembly A-HA may block the lower portion of the pipe A-41. The first plate A-21 may be disposed between the insertion space A-44 and the first space A-224. The first plate A-21 may separate the insertion space A-44 and the first space A-224 from each other.

The pipe A-41 may be insert-injection-molded together with the sealing member A-134. The pipe A-41 may be integrally connected to the sealing member A-134 in the heater assembly A-HA. The pipe A-41 and the sealing member A-134 may be integrally connected to each other through the inlet hole A-324. The pipe A-41 and the sealing member A-134 may be integrally connected to each other through the hook hole A-322.

The heater body A-11 and the heater tip A-12 may be disposed in the insertion space A-44. A cigarette may be inserted into the insertion space A-44, and the heater A-10 may penetrate the lower portion of the cigarette. The heater A-10 may be operated to heat the cigarette. The first lead wire A-161 and the second lead wire A-162 may be exposed downwards from the pipe A-41.

The latching portion A-415 may be formed of the second molding material A-100, formed by curing the first molding material A-100a introduced into the latching groove A-105. The latching portion A-415 may be integrally formed with the pipe A-41. The latching portion A-415 may protrude from the inner circumferential surface of the pipe A-41 in the radially inward direction. The latching portion A-415 may cover and support the upper edge of the first plate A-21. The latching portion A-415 may extend in the circumferential direction along the upper edge of the first plate A-21. The latching portion A-415 may prevent upward movement of the heater assembly A-HA.

The pipe bottom A-411 may be formed of the second molding material A-100, formed by curing the first molding material A-100a introduced into the first passage A-101, at a position near the recess portion A-321 (refer to FIG. 6). The pipe bottom A-411 may be formed at the lower portion of the pipe A-41. The pipe bottom A-411 may cover the recess portion A-321 (refer to FIG. 6). The pipe bottom A-411 may be in contact with the recess portion A-321, and may support the lower portion of the second cover A-30. The pipe bottom A-411 may prevent downward movement of the heater assembly A-HA.

The upper wall A-43 may extend outwards from the upper end of the pipe A-41. The upper wall A-43 may be formed of the second molding material A-100, formed by curing the first molding material A-100a introduced into the second passage A-102. The upper wall A-43 may form the upper portion of the housing A-40.

The outer wall A-42 may extend downwards from an end of the upper wall A-43. The outer wall A-42 may be formed of the second molding material A-100, formed by curing the first molding material A-100a introduced into the third passage A-103. The outer wall A-42 may form the outer side surface of the housing A-40. The outer wall A-42 may be spaced apart from the pipe A-41 in the outward direction. A space A-46 may be formed between the pipe A-41 and the outer wall A-42.

Accordingly, the gaps between the components of the heater assembly A-HA may be completely filled. In addition, the gap between the housing A-40 and the heater assembly A-HA may be completely filled. In addition, it is possible to prevent foreign substances, such as liquid, from leaking through the gap around the heater A-10.

In addition, the heater assembly A-HA may be stably fixed to or supported by the housing A-40. In addition, the first lead wire A-161 and the second lead wire A-162 may be prevented from becoming twisted with each other or becoming disconnected.

In addition, the process of assembling the heater assembly A-HA may be further simplified. In addition, the process of coupling the heater assembly A-HA and the housing A-40 to each other may be further simplified.

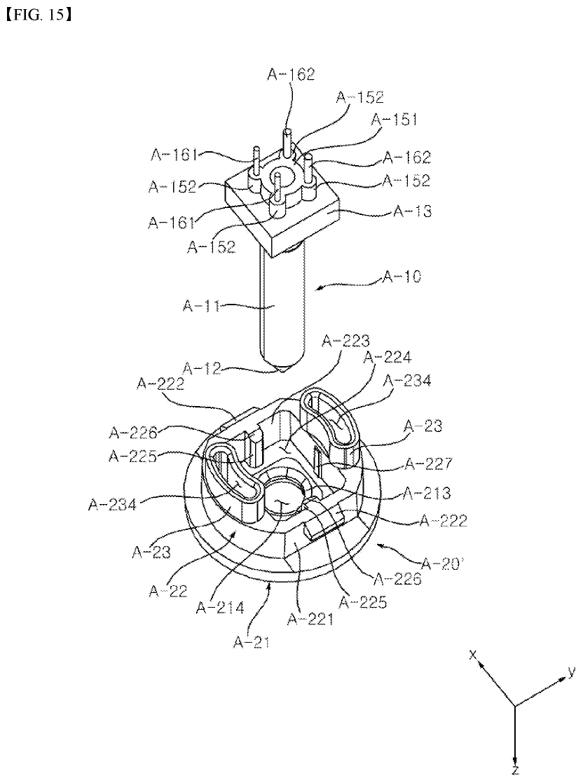

Referring to FIG. 15, a first cover A-20′ may include a column A-23. The column A-23 may be formed to protrude downwards from the lower portion of the first peripheral portion A-22. The column A-23 may be provided in a pair. The pair of columns A-23 may be disposed opposite each other with respect to the first space A-224. The pair of columns A-23 may face each other. The first cover A-20′ may include a positioning recess A-234. The positioning recess A-234 may be formed in such a manner that a portion of the column A-23 is recessed upwards. The positioning recess A-234 may be open downwards. Each of the pair of positioning recesses A-234 may be formed in a respective one of the pair of columns A-23. The pair of positioning recesses A-234 may have mutually different shapes. The upper end of the column A-23 may have a shape that is rounded toward the positioning recess A-234.

The first cover A-20′ may include support bars A-225 and A-227. The first support bars A-225 and the second support bars A-227 may protrude from the inner circumferential surface A-223 of the first peripheral portion A-22 toward the first space A-224. Each of the first support bars A-225 and the second support bars A-227 may have a shape that is elongated in the upward-downward direction. The first support bars A-225 may be disposed opposite each other with respect to the first space A-224. The second support bars A-227 may be disposed opposite each other with respect to the first space A-224. The first support bars A-225 and the second support bars A-227 may be alternately arranged in the circumferential direction. The second support bars A-227 may be formed to be inclined. Each of the second support bars A-227 may be inclined upwards from the lower end thereof toward the first space A-224.

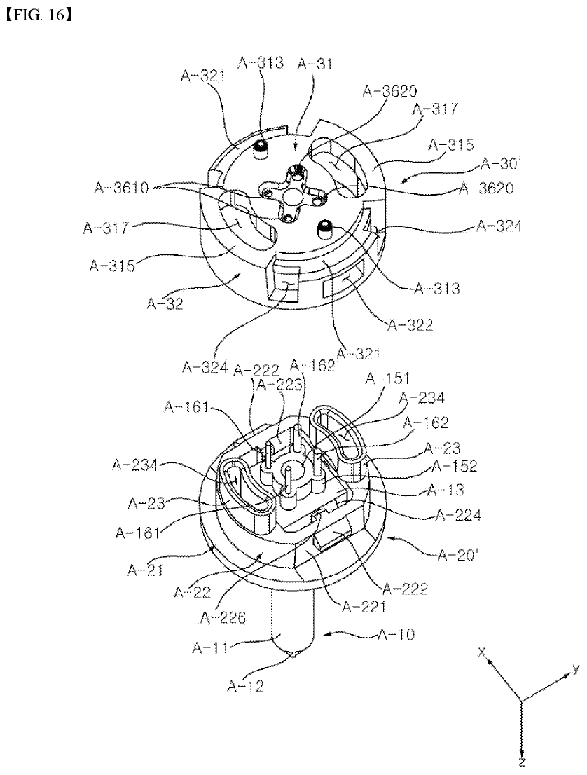

Referring to FIGS. 15 and 16, when the heater A-10 passes through the heater insertion hole A-214, the flange A-13 may slide while contacting the support guides A-226 and the second support bars A-227, and may be guided into the first space A-224. The first support bars A-225 and the second support bars A-227 may support the side portion of the flange A-13 disposed in the first space A-224. The first support bars A-225 and the second support bars A-227 may separate the flange A-13 from the first peripheral portion A-22, thereby forming a gap inside the first space A-224.

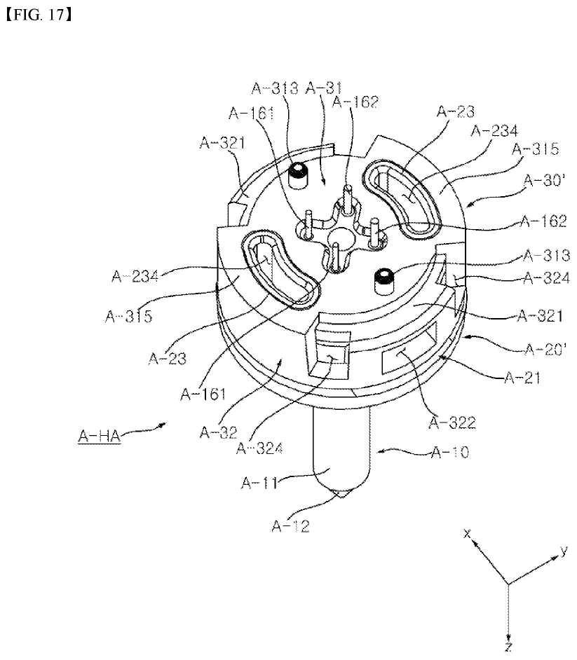

Referring to FIGS. 16 and 17, a second cover A-30′ may include a column hole A-317. The column hole A-317 may be formed in such a manner that a portion of the second plate A-31 is open. The column hole A-317 may be open in a shape corresponding to the column A-23. When the first cover A-20′ and the second cover A-30′ are coupled to each other, the column A-23 may be inserted into the column hole A-317. The column A-23 may pass through the column hole A-317, and thus the positioning recess A-234 may be exposed outside the second plate A-31.

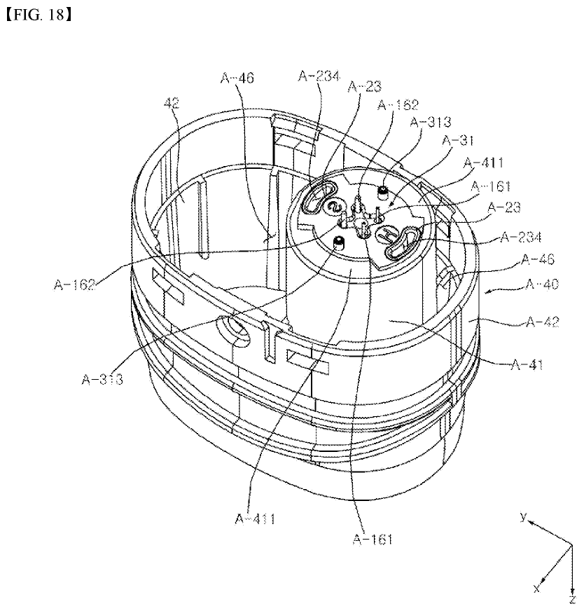

Referring to FIGS. 17 and 18, the positioning protrusion formed in the mold is inserted into the positioning recess A-234, thereby guiding the heater assembly A-HA to the correct position in the mold. Since the end of the column A-23 is formed to be rounded, the protrusion formed in the mold may slide into and be inserted in the positioning recess A-234.

Accordingly, after insert injection molding is completed, it is not necessary to remove the positioning protrusion from the heater assembly A-HA. As a result, the manufacturing method may be further simplified, and a trace may be prevented from remaining.

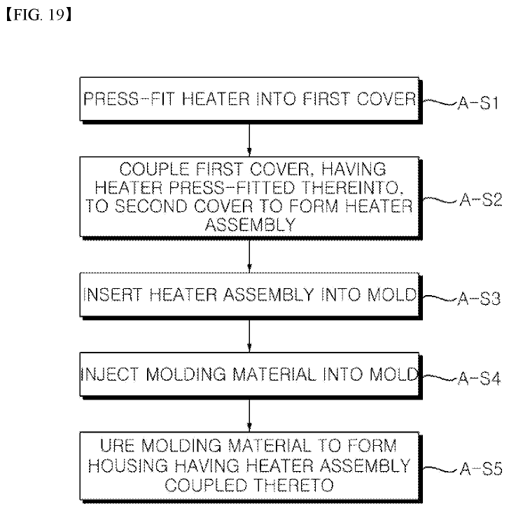

Referring to FIG. 19, the heater A-10 may be press-fitted into the first cover A-20 (A-S1). Thereafter, the heater assembly A-HA may be formed by coupling the first cover A-20, having the heater A-10 press-fitted thereinto, to the second cover A-30 (A-S2). Thereafter, the heater assembly A-HA may be inserted into the mold (A-S3). Thereafter, a molding material in a molten state may be injected into the mold having the heater assembly A-HA inserted thereinto (A-S4). Thereafter, the molding material may be cured, and the mold may be removed, whereby the housing A-40 to which the heater assembly A-HA is coupled may be formed (A-S5). A method of manufacturing the aerosol-generating device according to the present disclosure may include at least one of steps S1 to S5.

Referring to FIGS. 1 to 19, an aerosol-generating device in accordance with one aspect of the present disclosure may include a pipe A-41, a first plate A-21 to define an insertion space A-44, an elongated heater A-10 extending through the first plate A-21 such that one side of the heater is disposed in the insertion space A-44 and an opposite side of the heater is disposed in a sealing space A-C positioned opposite the insertion space with respect to the first plate, and a sealing member A-134 charged in the sealing space A-C.

In addition, in accordance with another aspect of the present disclosure, the sealing member A-134 may be connected with the pipe A-41.

In addition, in accordance with another aspect of the present disclosure, the aerosol-generating device may further include a cover including the first plate A-21 and having the sealing space A-C formed therein. The cover may be coupled to the pipe A-41.

In addition, in accordance with another aspect of the present disclosure, the cover may comprise an open lateral side leading to the sealing space A-C and at least one inlet hole A-324 formed at the open lateral side to allow the sealing member A-134 and the pipe A-41 to be connected to each other therethrough.

In addition, in accordance with another aspect of the present disclosure, the cover may include a first cover A-20, which includes the first plate A-21 comprising a heater insertion hole A-214 through which the heater A-10 passes,, a lower portion of the first cover defines an upper side of the sealing space A-C, and a second cover A-30, which is coupled to the first cover A-20, wherein an upper portion thereof defines a lower side of the sealing space A-C.

In addition, in accordance with another aspect of the present disclosure, the first cover A-20 may include a first peripheral portion A-22 extending downward from the first plate A-21 to define the side portion of the sealing space A-C.

In addition, in accordance with another aspect of the present disclosure, the first cover A-20 may include a support bar A-225 protruding inwardly from the first peripheral portion A-22 toward the sealing space A-C to support the side portion of the heater A-10 and to separate the heater A-10 from the first peripheral portion A-22 to form a gap in the sealing space A-C. The sealing member A-134 may be charged in the gap formed in the sealing space A-C to fix the heater A-10.

In addition, in accordance with another aspect of the present disclosure, an inclined support guide portion is formed at an end of the support bar A-225 to guide the heater into the heater insertion hole A-214.

In addition, in accordance with another aspect of the present disclosure, the support bar A-225 may be one of a plurality of the support bars arranged to be spaced apart from each other along the inner circumference of the first peripheral portion A-22. The aerosol-generating device may further include a non-circular flange A-13, which protrudes outwards from the heater A-10 and supported by the plurality of support bars A-225.

In addition, in accordance with another aspect of the present disclosure, the second cover A-30 may include a second plate A-31 defining the lower side of the sealing space A-C and configured to support the heater A-10, and a second peripheral portion A-32, which extends upward from the second plate A-31 to define a the side portion of the sealing space A-C.

In addition, in accordance with another aspect of the present disclosure, at least one inlet hole A-324 is formed at the second peripheral portion A-32.

In addition, in accordance with another aspect of the present disclosure, the first cover A-20 and the second cover A-30 may be coupled to each other in a snap-fit manner.

In addition, in accordance with another aspect of the present disclosure, the aerosol-generating device may further include a hook hole A-322, which is formed in the second cover A-30, and a hook A-222, which protrudes from the first cover A-20 and configured to engage with the hook hole A-322 to couple the first cover A-20 with the second cover A-30.

In addition, in accordance with another aspect of the present disclosure, a gap may be formed between the hook hole A-322 and the hook A-222 engaged with the hook hole A-322 the sealing member A-134 and the pipe A-41 connected to each other therethrough.

In addition, in accordance with another aspect of the present disclosure, the pipe may include a latching portion A-415, which protrudes inwards from the inner circumferential surface of the pipe A-41 toward the insertion space A-44, and covers the upper edge of the cover.

In addition, in accordance with another aspect of the present disclosure, the cover may include a positioning protrusion protruding downwards, and the positioning protrusion may be configured to engage with a recess formed in an injection mold to guide the cover to the correct position in the mold.

In addition, in accordance with another aspect of the present disclosure, the positioning protrusion may have different shapes.

In addition, in accordance with another aspect of the present disclosure, the positioning protrusion may be tapered.

In addition, in accordance with another aspect of the present disclosure, the cover may include a positioning recess A-234 at the lower portion of the cover configured to engage with a protrusion formed in an injection mold to guide the cover to the correct position in the mold.

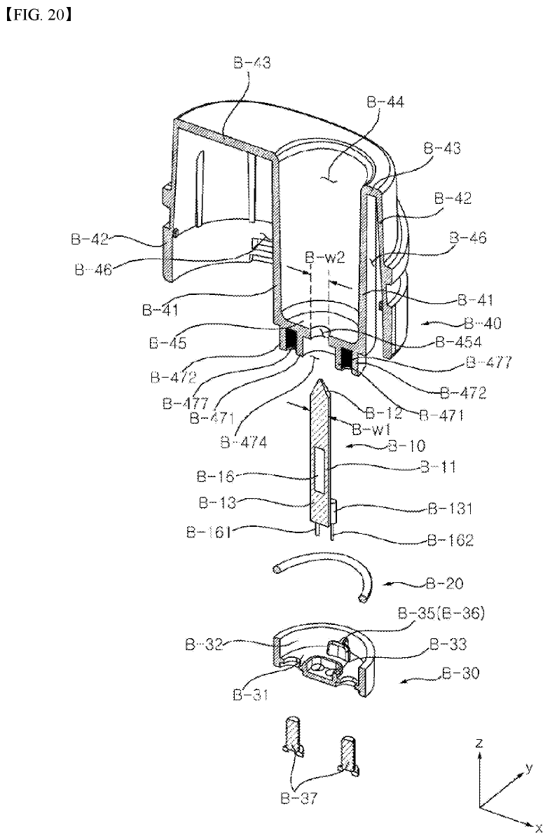

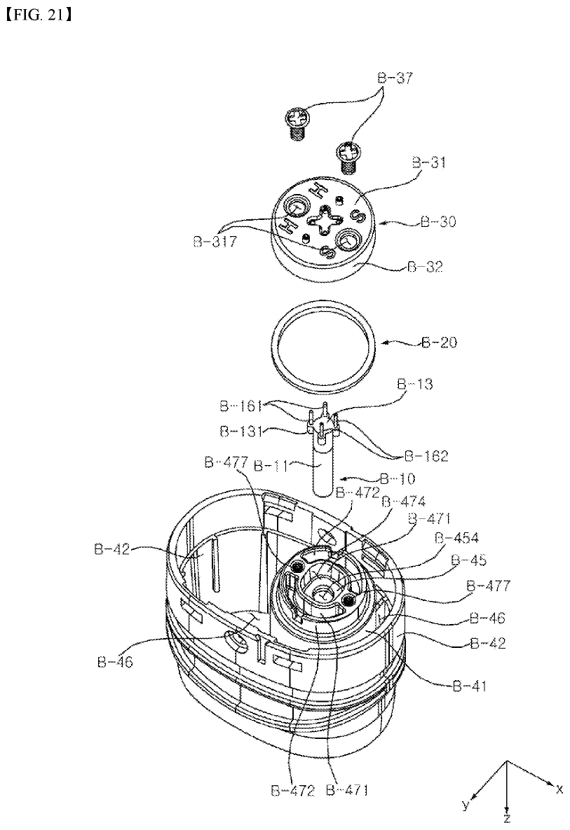

Referring to FIGS. 20 and 21, a housing B-40 may include a pipe B-41. The housing B-40 may include an outer wall B-42. The housing B-40 may include an upper wall B-43.

The pipe B-41 may have a cylindrical shape. The pipe B-41 may form an insertion space B-44 therein. The insertion space B-44 may have a cylindrical shape. The pipe B-41 and the insertion space B-44 may be formed to be elongated in the upward-downward direction. The upper side of the insertion space B-44 may be open to communicate with the outside. The lower side of the insertion space B-44 may be blocked by a partition B-45.

The partition B-45 may block the lower side of the insertion space B-44. The partition B-45 may have a disk shape. The partition B-45 may be integrally formed with the periphery of the lower end of the pipe B-41. The partition B-45 may be disposed perpendicular to the longitudinal direction of the pipe B-41. The partition B-45 may separate the insertion space B-44 and a sealing recess B-474 from each other. The partition B-45 may be integrally formed with the pipe B-41.

A heater insertion hole B-454 may be formed in such a manner than a portion of the partition B-45 is open. The heater insertion hole B-454 may be open in the upward-downward direction. The heater insertion hole B-454 may communicate with the insertion space B-44. The heater insertion hole B-454 may communicate with the sealing recess B-474.

The upper wall B-43 may extend outwards from the upper end of the pipe B-41. The upper wall B-43 may form the upper portion of the housing B-40. The outer wall B-42 may extend downwards from an end of the upper wall B-43. The outer wall B-42 may form the outer side surface of the housing B-40. The outer wall B-42 may be spaced apart from the pipe B-41 in the outward direction. A space B-46 may be formed between the pipe B-41 and the outer wall B-42.

The pipe B-41 may include a sealing wall B-471. The sealing wall B-471 may be formed beneath the pipe B-41. The sealing wall B-471 may protrude downwards from the partition B-45. The sealing wall B-471 may extend in the circumferential direction. The sealing wall B-471 may surround the sealing recess B-474, which is open downwards. The sealing wall B-471 may surround the side portion of the sealing recess B-474.

The sealing recess B-474 may be formed below the partition B-45. The sealing recess B-474 may communicate with a heater insertion hole B-454. The sealing recess B-474 may be open downwards. The width of the sealing recess B-474 may be greater than the width of the heater insertion hole B-454. The sealing recess B-474 may also be referred to as a sealing space B-474.

A heater B-10 may be formed to be elongated in the upward-downward direction. The heater B-10 may have a cylindrical shape. The heater B-10 may be pointed at one end. The heater B-10 may be heated by directly receiving power, or may be heated by an induction-heating method using an induction coil disposed near the heater. The heater B-10 may penetrate the partition B-45. The heater B-10 may be inserted into the heater insertion hole B-454. The upper portion of the heater B-10 may be disposed in the insertion space B-44. The lower portion B-13 of the heater B-10 may be disposed in the sealing recess B-474.

The heater B-10 may include a heater body B-11. The heater body B-11 may be elongated in the upward-downward direction. The heater body B-11 may have a cylindrical shape. The heater B-10 may include a heater tip B-12. The heater tip B-12 may be formed at one end of the heater B-10. The heater tip B-12 may be integrally formed with the upper side of the heater body B-11. The heater tip B-12 may have a shape that is gradually narrowed in the upward direction. The heater tip B-12 may be pointed at one end. The heater B-10 may pierce a cigarette.

Protruding portions B-131 may be formed around the lower portion B-13 of the heater B-10. The protruding portions B-131 may protrude from the outer circumferential surface of the lower portion B-13 of the heater B-10 in the radially outward direction. Each of the protruding portions B-131 may be formed in the shape of a cylinder that extends in the upward-downward direction. The plurality of protruding portions B-131 may be arranged so as to be spaced apart from each other in the circumferential direction along the outer circumferential surface of the lower portion B-13 of the heater B-10.

One of the protruding portions B-131 may surround and fix a first lead wire B-161. The other of the protruding portions B-131 may surround and fix a second lead wire B-162. The number of protruding portions B-131 may correspond to the number of first and second lead wires B-161 and B-162. For example, when two first lead wires B-161 and two second lead wires B-162 are provided, the number of protruding portions B-131 may be four.

The first lead wire B-161 may be exposed downwards from a portion peripheral to the lower portion B-13 of the heater B-10. The first lead wire B-161 may penetrate the protruding portion B-131. The first lead wire B-161 may be electrically connected to the heater B-10 to transmit power to the heater B-10. The heater B-10 may generate heat using the power received from the first lead wire B-161. The first lead wire B-161 may be provided in a pair.

The second lead wire B-162 may be exposed downwards from a portion peripheral to the lower portion B-13 of the heater B-10. The second lead wire B-162 may penetrate the protruding portion B-131. The heater B-10 may be formed to be hollow. A sensor B-16 may be mounted inside the heater B-10. The sensor B-16 may sense the temperature of the heater B-10. The second lead wire B-162 may be electrically connected to the sensor B-16 to transmit power to the sensor B-16. The second lead wire B-162 may be provided in a pair. The first lead wire B-161 and the second lead wire B-162 may be disposed opposite each other with respect to the lower portion B-13 of the heater B-10. The first lead wire B-161 and the second lead wire B-162 may have mutually different thicknesses.

The heater B-10 may be press-fitted into the heater insertion hole B-454. The width B-w1 of the heater body B-11 may be equal to or slightly greater than the width B-w2 of the heater insertion hole B-454. The heater body B-11 may be press-fitted into the heater insertion hole B-454. The heater insertion hole B-454 may be completely filled by the heater body B-11.

A sealing ring B-20 may be formed in the shape of a ring having an open interior. The sealing ring B-20 may be made of an elastic material. For example, the sealing ring B-20 may be made of rubber or silicon. The sealing ring B-20 may be disposed between the pipe B-41 and a cover B-30.

The cover B-30 may be coupled to the lower side of the pipe B-41. The cover B-30 may include a cover bottom portion B-31 and a cover peripheral portion B-32. The cover bottom portion B-31 may have a disk shape. The cover peripheral portion B-32 may extend upwards along the edge of the cover bottom portion B-31. A screw B-37 may pass through a fastening hole B-317 formed in the cover bottom portion B-31 to couple the cover B-30 to the pipe B-41.

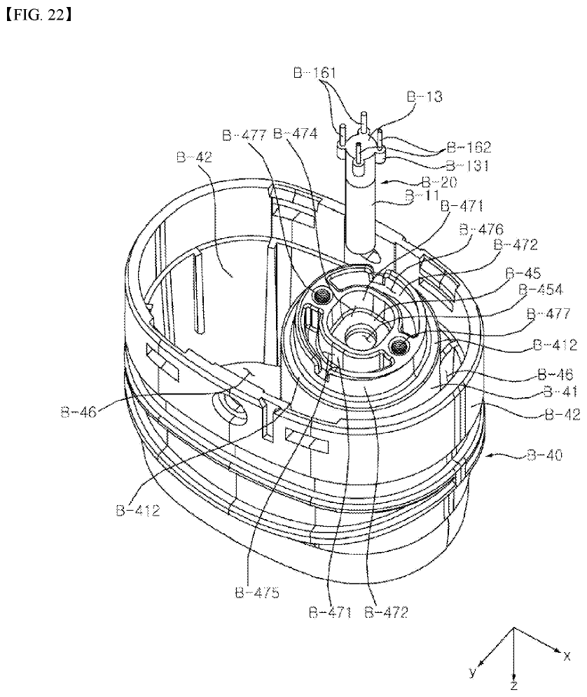

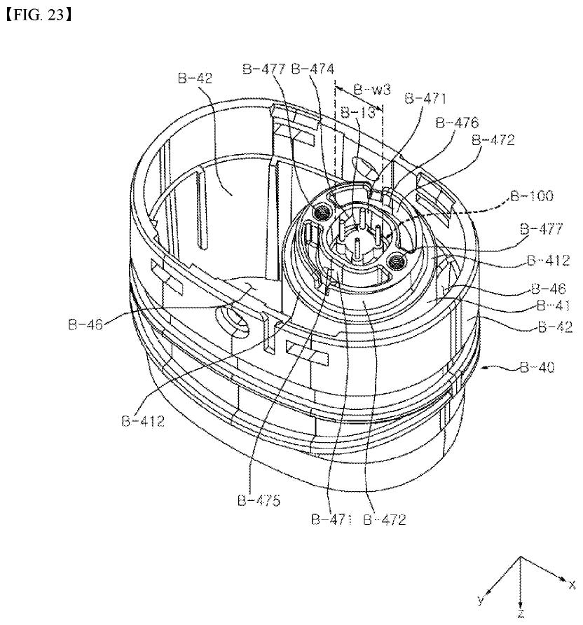

Referring to FIGS. 22 and 23, the sealing recess B-474 may be defined by the partition B-45 and the sealing wall B-471. The partition B-45 may cover the upper side of the sealing recess B-474. The sealing wall B-471 may surround the side portion of the partition B-45. The sealing recess B-474 may be open downwards. The sealing recess B-474 may communicate with the heater insertion hole B-454.

The heater B-10 may penetrate the partition B-45. The heater B-10 may be inserted into the heater insertion hole B-454, or may pass through the heater insertion hole B-454. The heater B-10 may be press-fitted into the heater insertion hole B-454, and may be fixed to the partition B-45.

When the heater B-10 penetrates the partition B-45, the upper portion of the heater B-10 may protrude into the insertion space B-44 (refer to FIG. 20), and the lower portion B-13 thereof may be disposed in the sealing recess B-474. The protruding portions B-131 may protrude outwards from the lower portion B-13 of the heater B-10. The protruding portions B-131 may be disposed in the sealing recess B-474. The lower portion B-13 of the heater B-10 and the protruding portions B-131 may be surrounded by the sealing wall B-471. The heater B-10 may be spaced apart from the sealing wall B-471, so a space may be formed in the sealing recess B-474. The protruding portions B-131 may be caught by the partition B-45 around the heater insert hole B-454, or may be prevented from passing through the heater insert hole B-454.

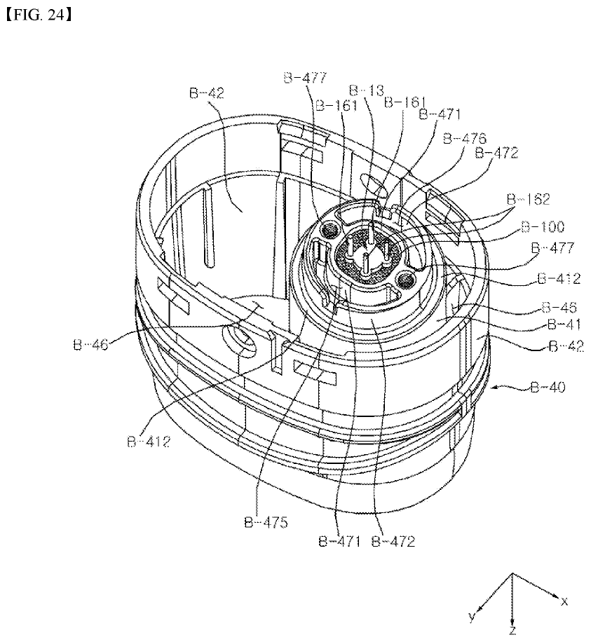

Referring to FIGS. 23 and 24, a filler B-100 may be charged in the sealing recess B-474. The filler B-100 may be injected in a liquid state, and may be cured after a predetermined period of time elapses. The filler B-100 may be injected into the sealing recess B-474 through the opening in the sealing recess B-474. The filler B-100 may be made of an adhesive material. The filler B-100 may surround the lower portion B-13 of the heater B-10 and the protruding portions B-131. The filler B-100 may fix the lower portion B-13 of the heater B-10. The filler B-100 may provide the protruding portions B-131 with force resistant to rotation in the circumferential direction. The material of the filler B-100 may be the same as the material of the heater body B-11 or the material of the lower portion B-13 of the heater B-10. The filler B-100 may also be referred to as a sealing member B-100.

Accordingly, the filler B-100 may seal the sealing recess B-474 and the periphery of the sealing recess B-474, and may prevent liquid from entering the gap between the heater B-10 and the heater insertion hole B-454. In addition, the filler B-100 may prevent the lower portion B-13 of the heater B-10 and the protruding portions B-131 from moving or rotating.

The pipe B-41 may include a recess portion B-472. The recess portion B-472 may form the periphery of the lower portion of the pipe B-41. The recess portion B-472 may extend in the circumferential direction. The recess portion B-472 may protrude downwards from the partition B-45. The recess portion B-472 may be recessed from the outer circumferential surface of the pipe B-41 in the radially inward direction.

The recess portion B-472 may be spaced apart from the sealing wall B-471 in the outward direction. Positioning recesses B-475 and B-476 may be formed between the sealing wall B-471 and the recess portion B-472. The positioning recesses B-475 and B-476 may be open downwards. The plurality of positioning recesses B-475 and B-476 may include a first positioning recess B-475 and a second positioning recess B-476, which are disposed opposite each other with respect to the sealing recess B-474.

The pipe B-41 may include a step portion B-412. The step portion B-412 may be formed in such a manner that the periphery of the lower portion of the pipe B-41 is recessed inwards, and may be integrally formed with the recess portion B-472. The step portion B-412 may face downwards. The step portion B-412 may extend from the upper end of the recess portion B-472 in the radially outward direction, and may interconnect the pipe B-41 and the recess portion B-472.

A screw hole B-477 may be formed near the sealing recess B-474. The screw hole B-477 may have a thread formed therein. The screw hole B-477 may be open downwards. The screw hole B-477 may be formed between the sealing wall B-471, the first positioning recess B-475, and the second positioning recess B-476. The screw hole B-477 may be formed in a plural number. The plurality of screw holes B-477 may be disposed opposite each other with respect to the sealing recess B-474. The plurality of screw holes B-477 may be spaced apart from each other around the sealing recess B-474.

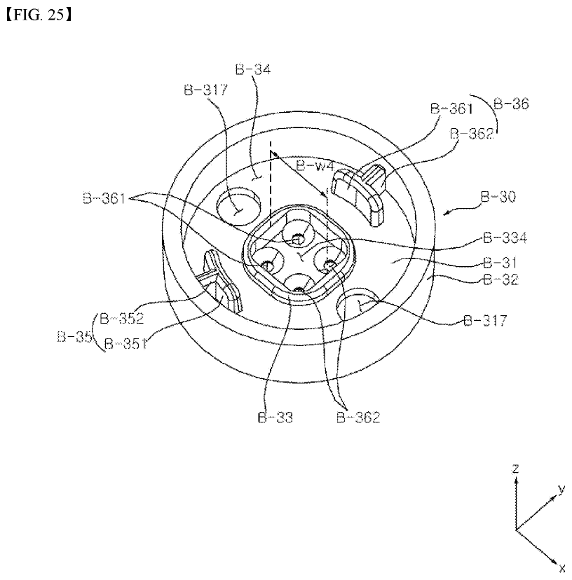

Referring to FIG. 25, the cover B-30 may include a cover bottom portion B-31 and a cover peripheral portion B-32. The cover bottom portion B-31 may have a disk shape. The cover peripheral portion B-32 may extend upwards along the edge of the cover bottom portion B-31. The cover peripheral portion B-32 may extend in the circumferential direction.

A space B-34 may be formed inside the cover B-30. The cover bottom portion B-31 may cover the lower portion of the space B-34. The cover peripheral portion B-32 may surround the side portion of the space B-34. The space B-34 may be open upwards.

Wire holes B-361 and B-362 may be formed in such a manner that some portions of the cover bottom portion B-31 are open. The wire holes B-361 and B-362 may communicate with the space B-34. The wire holes B-361 and B-362 may be formed in a plural number. The number of wire holes B-361 and B-362 may correspond to the number of lead wires B-161 and B-162.

The first lead wire B-161 and the second lead wire B-162 may have mutually different thicknesses or mutually different colors. The first lead wire B-161 and the second lead wire B-162 may be distinguishable from each other. The diameter of the first wire hole B-361 may correspond to the thickness of the first lead wire B-161. The diameter of the second wire hole B-362 may correspond to the thickness of the second lead wire B-162. Each of the pair of first lead wires B-161 may pass through a respective one of the pair of first wire holes B-361. Each of the pair of second lead wires B-162 may pass through a respective one of the pair of second wire holes B-362. The first wire hole B-361 may be disposed at a position corresponding to the first lead wire B-161, and the second wire hole B-362 may be disposed at a position corresponding to the second lead wire B-162.

A blocking wall B-33 may protrude upwards from the cover bottom portion B-31 at a position around the wire holes B-361 and B-362. The blocking wall B-33 may extend in the circumferential direction so as to surround the wire holes B-361 and B-362. The plurality of wire holes B-361 and B-362 may be located inside the blocking wall B-33.

The fastening hole B-317 may be formed in such a manner that a portion of the cover bottom portion B-31 is open. The fastening hole B-317 may communicate with the space B-34. The fastening hole B-317 may be located outside the blocking wall B-33.

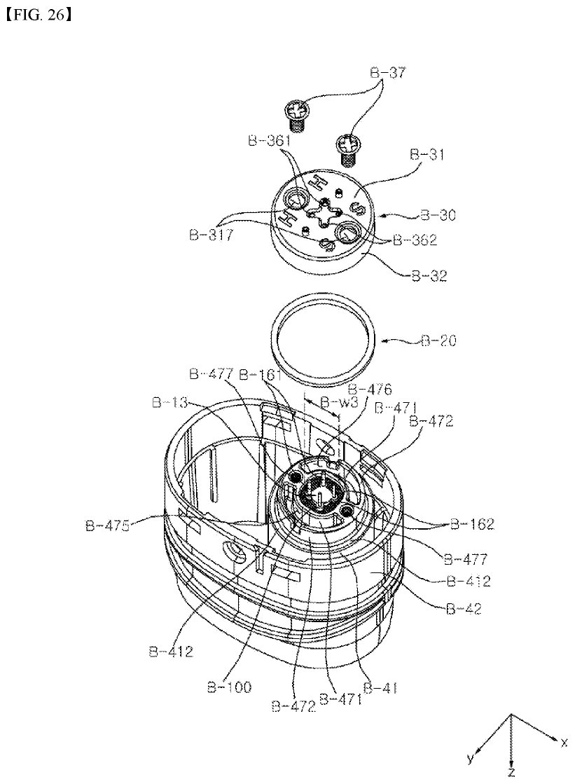

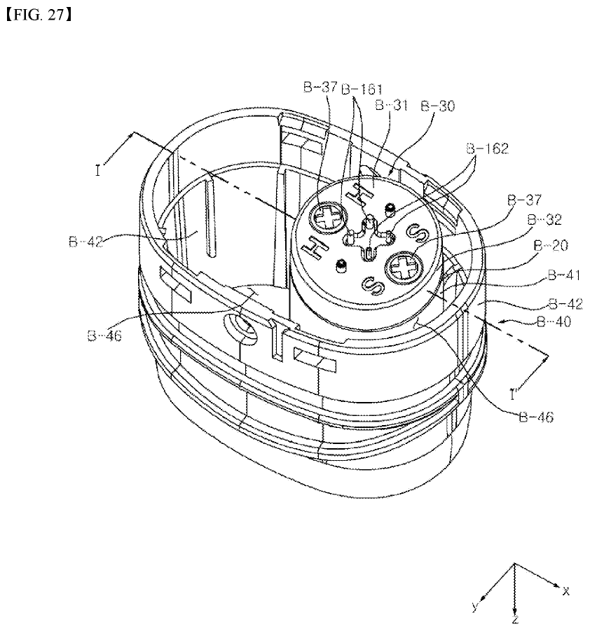

Referring to FIGS. 25 to 27, the cover B-30 may be coupled to the lower side of the pipe B-41. The cover B-30 may cover the opening in the sealing recess B-474. The cover B-30 may cover and seal the filler B-100 charged in the sealing recess B-474. The sealing wall B-471 and the recess portion B-472 may be inserted into the space B-34 in the cover B-30, and thus may be surrounded by the cover B-30. The sealing wall B-471, the recess portion B-472, and the sealing recess B-474 may not be exposed outside the cover B-30.

The cover bottom portion B-31 of the cover B-30 may cover the opening in the sealing recess B-474. The cover bottom portion B-31 may cover the filler B-100 charged in the sealing recess B-474. The cover bottom portion B-31 may support the lower portion B-13 of the heater B-10. The cover bottom portion B-31 may cover or support the lower portion of the sealing wall B-471. The cover bottom portion B-31 may cover or support the lower portion of the recess portion B-472.

The cover peripheral portion B-32 of the cover B-30 may cover the side portion of the sealing wall B-471. The cover peripheral portion B-32 may cover or support the side portion of the recess portion B-472. The cover peripheral portion B-32 may be spaced apart from the lower side of the step portion B-412 of the pipe B-41. The diameter of the outer circumferential surface of the cover peripheral portion B-32 may be equal to or similar to the diameter of the outer circumferential surface of the pipe B-41.

The screw B-37 may fix the cover B-30 to the other side of the pipe B-41. The screw B-37 may pass through the fastening hole B-317 formed in the cover B-30, and may be inserted and threaded into the screw hole B-47. Each of the screw B-37, the fastening hole B-317, and the screw hole B-47 may be provided in a plural number. The screw B-37 may fix the cover B-30 in the upward direction. The screw B-37 may be in close contact with the fastening hole B-317 to seal the same.

Accordingly, the cover B-30 may protect the filler B-100, the heater B-10, and the periphery of the sealing recess B-474 from the outside. In addition, it is possible to prevent the droplets introduced into the sealing recess B-474 from entering the aerosol-generating device beyond the cover B-30. In addition, the cover B-30 may minimize thermal deformation of the structure near the heater B-10 due to the heat generated by the heater B-10.

The sealing ring B-20 may be formed in the shape of a ring having an open interior. The sealing ring B-20 may be disposed between the pipe B-41 and the cover B-30. The sealing ring B-20 may be in contact with the recess portion B-472 and the step portion B-412 of the pipe B-41. The sealing ring B-20 may be in contact with the lower side of the step portion B-412. The diameter of the sealing ring B-20 may be equal to or similar to the diameter of the step portion B-412. The sealing ring B-20 may be in contact with the outer circumferential surface of the recess portion B-472. The recess portion B-472 and the sealing wall B-471 may pass through the inner space in the sealing ring B-20.

The cover peripheral portion B-32 may be in contact with the lower portion of the sealing ring B-20. The sealing ring B-20 may be disposed between the step portion B-412 of the pipe B-41, the outer circumferential surface of the recess portion B-472, and the upper end of the cover peripheral portion B-32 so as to be in close contact therewith. The cover peripheral portion B-32 may press the sealing ring B-20 from below to above toward the step portion B-412 of the pipe B-41.

Accordingly, it is possible to prevent droplets from leaking through the gap around the sealing ring B-20.

Positioning protrusions B-35 and B-36 may protrude upwards from the cover bottom portion B-31. The positioning protrusions B-35 and B-36 may be disposed outside the blocking wall B-33. Each of the positioning protrusions B-35 and B-36 may have a shape corresponding to a respective one of the positioning recesses B-475 and B-476. The positioning protrusions B-35 and B-36 may be inserted into the positioning recesses B-475 and B-476, thereby guiding the cover B-30 to the correct position.

The first positioning protrusion B-35 and the second positioning protrusion B-36 may have mutually different shapes. Each of the first positioning protrusion B-35 and the second positioning protrusion B-36 may be disposed at a position biased in any one direction. The first positioning protrusion B-35 may have a shape corresponding to the first positioning recess B-475. The first positioning protrusion B-35 may be inserted into the first positioning recess B-475. The second positioning protrusion B-36 may have a shape corresponding to the second positioning recess B-476. The second positioning protrusion B-36 may be inserted into the second positioning recess B-476. Due to the first positioning protrusion B-35 and the second positioning protrusion B-36, the first wire hole B-361 may be disposed at a position corresponding to the first lead wire B-161, and the second wire hole B-362 may be disposed at a position corresponding to the second lead wire B-162.

The first lead wire B-161 may be exposed outside the cover B-30 through the first wire hole B-361. The second lead wire B-162 may be exposed outside the cover B-30 through the second wire hole B-362.

Accordingly, the cover B-30 may be coupled in the correct direction, and the first lead wire B-161 and the second lead wire B-162 may be prevented from becoming twisted with each other or becoming disconnected inside or outside the cover B-30.

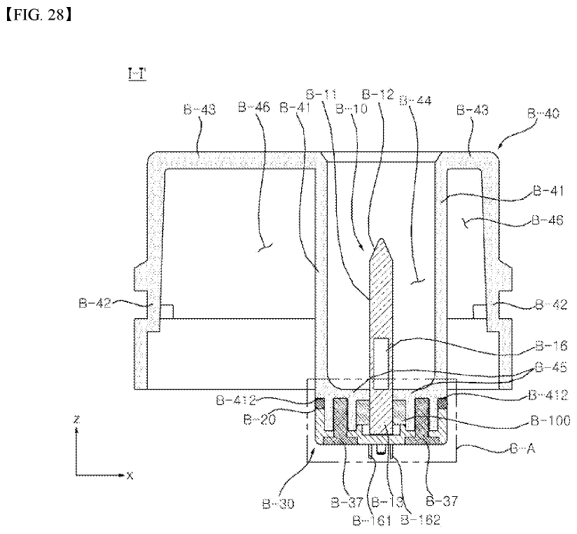

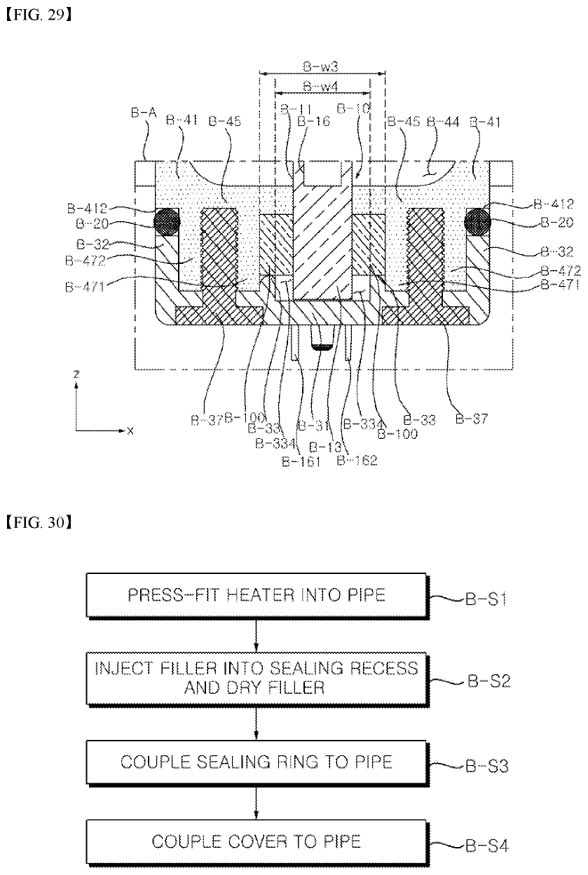

Referring to FIGS. 28 and 29, the filler B-100 may be formed of the same material as the lower portion B-13 of the heater B-10. The filler B-100 may be integrally formed with the lower portion B-13 of the heater B-10. The coefficient of thermal expansion of the filler B-100 may be equal to or similar to that of the heater B-10.

Accordingly, even if the structure near the heater B-10 is thermally deformed due to the heat generated by the heater B-10, no gap may be formed between the heater B-10 and the filler B-100.

The width B-w4 of the inner peripheral surface of the blocking wall B-33 may be smaller than the width B-w3 of the inner peripheral surface of the sealing recess B-474. The shape of the outer peripheral surface of the blocking wall B-33 may correspond to the shape of the inner peripheral surface of the sealing wall B-471. The height of the filler B-100 charged in the sealing recess B-474 may be lower than the height of the sealing wall B-471. The blocking wall B-33 may be disposed below the filler B-100. The blocking wall B-33 may protrude upwards from the cover bottom portion B-31 of the cover B-30. The blocking wall B-33 may be inserted into the opening in the sealing recess B-474. The sealing ring B-20 may be disposed between the step portion B-412 of the pipe B-41, the outer circumferential surface of the recess portion B-472, and the upper end of the cover peripheral portion B-32 so as to be in close contact therewith, thereby filling the gaps formed therebetween.

Accordingly, even if the structure near the heater B-10 is thermally deformed due to the heat generated by the heater B-10 and thus liquid enters the sealing recess B-474, the blocking wall B-33 may prevent the liquid from leaking outside the cover B-30 through the wire holes B-361 and B-362 (refer to FIG. 25). In addition, the sealing ring B-20 may prevent the liquid from leaking through the gap between the cover peripheral portion B-32 of the cover B-30 and the step portion B-412 of the pipe B-41.

Referring to FIG. 30, a method of manufacturing the aerosol-generating device may include a step of passing the heater B-10 through the partition B-45, which blocks one side of the insertion space B-44 (B-S1). In step S1, the lower portion B-13 of the heater B-10 may be disposed in the sealing recess B-474.

The method of manufacturing the aerosol-generating device may include a step of injecting the filler B-100 in a liquid state so as to completely fill the sealing recess B-474 and drying the same (B-S2). In step S2, the filler B-100 may surround the lower portion B-13 of the heater B-10 in the sealing recess B-474, and may fix the heater B-10.

The method of manufacturing the aerosol-generating device may include a step of coupling the sealing ring B-20 to the periphery of the pipe B-41 (B-S3). In step S3, the sealing ring B-20 may be in close contact with the outer circumferential surfaces of the step portion B-412 and the recess portion B-472 of the pipe B-41.

The method of manufacturing the aerosol-generating device may include a step of coupling the cover B-30 to the lower side of the pipe B-41 to cover the sealing recess B-474 (B-S4). In step S4, the cover B-30 may press the sealing ring B-20 onto the step portion B-412 of the pipe B-41.

Referring to FIGS. 20 to 30, an aerosol-generating device in accordance with one aspect of the present disclosure may include a pipe B-41, a first plate B-45 partitioning an inside of the pipe B-41 to define an insertion space B-44, an elongated heater B-10 extending through the first plate B-45 such that one side of the heater is disposed in the insertion space B-44 and an opposite side of the heater is disposed in a sealing space B-474 positioned opposite the insertion space with respect to the first plate, and a sealing member B-100 charged in the sealing space B-474.

In addition, in accordance with another aspect of the present disclosure may include a pipe B-41 having two open opposite sides, a partition B-45 partitioning the inside of the pipe B-41 into an insertion space B-44, located adjacent to one side of the pipe B-41, and a sealing recess B-474, located adjacent to the opposite side of the pipe B-41, a heater B-10 elongated to penetrate the partition B-45 so that a portion thereof is disposed in the sealing recess B-474, and a filler B-100 charged in the sealing recess B-474.

In addition, in accordance with another aspect of the present disclosure, the aerosol-generating device may further include a cover B-30 coupled to the opposite side of the pipe B-41 to cover an opening in the sealing recess B-474.

In addition, in accordance with another aspect of the present disclosure, the cover B-30 may support the lower portion of the heater B-10.

In addition, in accordance with another aspect of the present disclosure, the cover B-30 may have wire holes B-361 and B-362 formed to be open to allow lead wires B-161 and B-162, which are electrically connected to the heater B-10, to pass therethrough.

In addition, in accordance with another aspect of the present disclosure, the cover B-30 may include a blocking wall B-33 protruding so as to surround the wire holes B-361 and B-362.

In addition, in accordance with another aspect of the present disclosure, the width B-w4 of the inner circumferential surface of the blocking wall B-33 may be smaller than the width B-w3 of the sealing recess B-474.

In addition, in accordance with another aspect of the present disclosure, the blocking wall B-33 may be inserted into the opening in the sealing recess B-474.

In addition, in accordance with another aspect of the present disclosure, the aerosol-generating device may further include a sealing ring B-20 disposed between the pipe B-41 and the cover B-30.

In addition, in accordance with another aspect of the present disclosure, the cover B-30 may include a cover bottom portion B-31, which covers the opening in the sealing recess B-474, and a cover peripheral portion B-32, which protrudes from the edge of the cover bottom portion B-31 and extends in the circumferential direction to surround the opposite side of the pipe B-41.

In addition, in accordance with another aspect of the present disclosure, the pipe B-41 may include a step portion B-412 recessed inwards from the periphery of the opposite side thereof, and the aerosol-generating device may further include a sealing ring B-20 disposed between the step portion B-412 and the cover peripheral portion B-32.

In addition, in accordance with another aspect of the present disclosure, when the cover B-30 is coupled to the opposite side of the pipe B-41, the cover peripheral portion B-32 may press the sealing ring B-20 onto the step portion B-412.

In addition, in accordance with another aspect of the present disclosure, the aerosol-generating device may further include a screw B-37 configured to fix the cover B-30 to the opposite side of the pipe B-41.

In addition, in accordance with another aspect of the present disclosure, positioning recesses B-475 and B-476 may be formed near the sealing recess B-474 so as to be open in the opposite side of the pipe B-41, and the cover B-30 may include positioning protrusions B-35 and B-36 formed so as to be inserted into the positioning recesses B-475 and B-476 to guide the cover B-30 to the correct position.

In addition, in accordance with another aspect of the present disclosure, the partition B-45 may have a heater insertion hole B-454 formed to be open to allow the insertion space B-44 and the sealing recess B-474 to be connected to each other therethrough, and the heater B-10 may be press-fitted into the heater insertion hole B-454.

In addition, in accordance with another aspect of the present disclosure, the aerosol-generating device may further include protruding portions B-131 protruding from an circumferential surface of an opposite side of the heater B-10 in the radially outward direction, and the protruding portions B-131 may be formed to be disposed in the sealing recess B-474 but to be prevented from passing through the heater insertion hole B-454.

In addition, in accordance with another aspect of the present disclosure, the pipe B-41 and the partition B-45 may be integrally formed with each other.

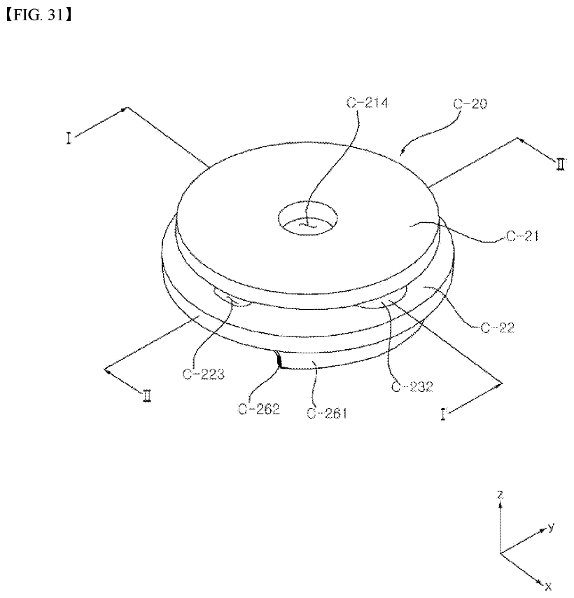

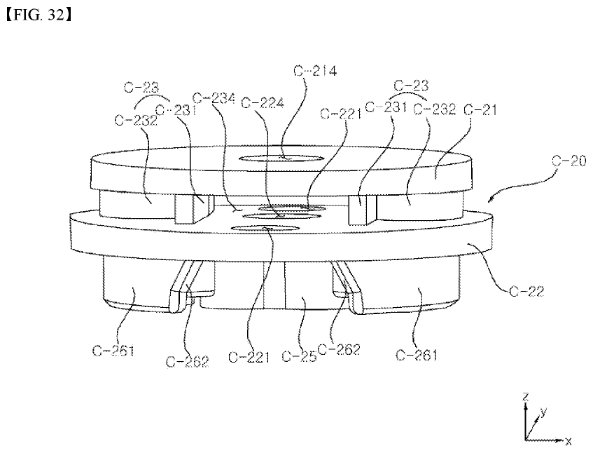

Referring to FIGS. 31 and 32, a first cover C-20 may include a first plate C-21. The first cover C-20 may include a second plate C-22.

The first plate C-21 may be formed at the upper portion of the first cover C-20. The first plate C-21 may be disposed above the second plate C-22. The first plate C-21 may have a flat shape. The first plate C-21 may have a disk shape. A first insertion hole C-214 may be formed in such a manner that a portion of the first plate C-21 is open. The first insertion hole C-214 may be formed in the center of the first plate C-21. The first insertion hole C-214 may be open in the upward-downward direction.

The second plate C-22 may be formed at the lower portion of the first cover C-20. The second plate C-22 may be disposed below the first plate C-21. The second plate C-22 may have a flat shape. The second plate C-22 may have a disk shape. A second insertion hole C-224 may be formed in such a manner that a portion of the second plate C-22 is open. The second insertion hole C-224 may be formed in the center of the second plate C-22. The second insertion hole C-224 may be open in the upward-downward direction. The second insertion hole C-224 may be disposed at a position corresponding to the first insertion hole C-214. The first insertion hole C-214 and the second insertion hole C-224 may be disposed parallel to each other while facing each other in the upward-downward direction. The second plate C-22 may have a larger circumference than the first plate C-21.

The first plate C-21 and the second plate C-22 may be spaced apart from each other in the upward-downward direction. The first plate C-21 and the second plate C-22 may be disposed parallel to each other. A space C-234 may be located between the first plate C-21 and the second plate C-22. The space C-234 may be located under the first plate C-21. The space C-234 may be disposed on the second plate C-22. The first insertion hole C-214 may communicate with the space C-234. The second insertion hole C-224 may communicate with the space C-234. At least a portion of the space C-234 may be disposed between the first insertion hole C-214 and the second insertion hole C-224. The thickness of the first plate C-21 and the thickness of the second plate C-22 may be equal to or similar to each other. The space C-234 may also be referred to as a sealing space C-234.

The first cover C-20 may include a spacer C-23. The spacer C-23 may be disposed between the first plate C-21 and the second plate C-22. The spacer C-23 may be connected to the first plate C-21 and the second plate C-22. The spacer C-23 may be provided in a plural number. The plurality of spacers C-23 may be disposed with the space C-234 interposed therebetween. The pair of spacers C-23 may be disposed with the space C-234 interposed therebetween. The spacers C-23 may be spaced apart from the first insertion hole C-214. The spacers C-23 may be spaced apart from the second insertion hole C-224. The thickness of each of the spacers C-23 may be equal to or similar to the thickness of the first plate C-21 and/or the thickness of the second plate C-22. The spacers C-23 may be recessed inwards from the edge of the first plate C-21 and the edge of the second plate C-22.

The pair of spacers C-23 may support two opposite sides of the first plate C-21 and two opposite sides of the second plate C-22. The pair of spacers C-23 may be disposed opposite each other with respect to the space C-234. The pair of spacers C-23 may face each other with the space C-234 interposed therebetween. The spacers C-23 may provide the first plate C-21 and the second plate C-22 with force resistant to deformation. For example, the first plate C-21 and the second plate C-22 may be prevented from being thermally deformed by insert injection molding or by the heat generated by a heater, which will be described later.

The space C-234 may be surrounded by the first plate C-21, the second plate C-22, and the spacers C-23. The first plate C-21 may cover the upper portion of the space C-234. The second plate C-22 may cover the lower portion of the space C-234. The pair of spacers C-23 may cover two opposite sides of the space C-234. At least one side of the space C-234 may be open. The space C-234 may be open to the outside between the pair of spacers C-23.

Each of the spacers C-23 may include an inner spacer C-231 and an outer spacer C-232. The inner spacer C-231 may cover one side of the space C-234. The inner spacer C-231 may be disposed closer to the space C-234 than the outer spacer C-232. The inner spacer C-231 may be formed to be elongated in the radial direction of the first plate C-21 or the radial direction of the second plate C-22. The pair of inner spacers C-231 may extend parallel to each other in one direction, with the space C-234 interposed therebetween. The pair of inner spacers C-231 may face each other with the space C-234 interposed therebetween. The inner spacers C-231 may support portions peripheral to the centers of the first plate C-21 and the second plate C-22.

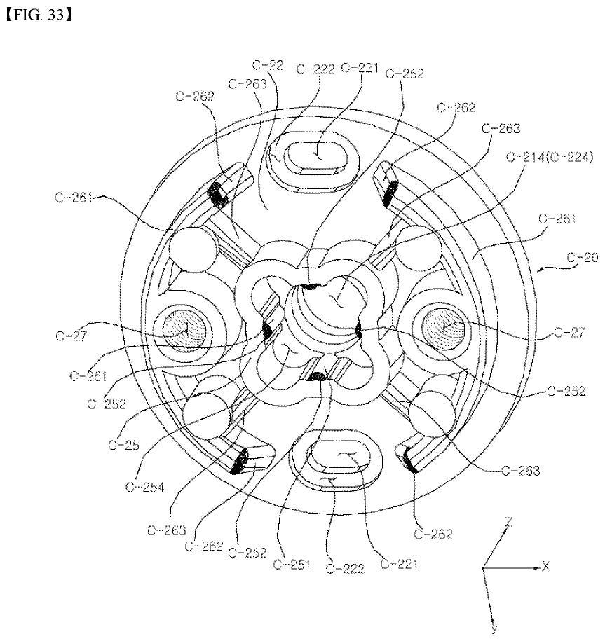

The outer spacer C-232 may be disposed outside each of the inner spacers C-231. The outer spacer C-232 may support portions peripheral to the edges of the first plate C-21 and the second plate C-22. The outer spacer C-232 may be formed to be rounded along the circumferences of the first plate C-21 and the second plate C-22. The outer spacer C-232 may be recessed from the circumference of the first plate C-21 in the radially inward direction. The outer spacer C-232 may be recessed from the circumference of the second plate C-22 in the radially inward direction. A screw hole C-27 may be formed in each of the inner spacers C-231 (refer to FIG. 33).

Referring to FIGS. 32 and 33, the first cover C-20 may include a hub C-25. The hub C-25 may protrude downwards from the second plate C-22. The hub C-25 may surround the second insertion hole C-224. The hub C-25 may surround the side portion of a third insertion hole C-254. The third insertion hole C-254 may be disposed below the second insertion hole C-224. The third insertion hole C-254 may communicate with the second insertion hole C-224. Each of the inner circumferential surfaces of the hub C-25 and the third insertion hole C-254 may have a non-circular shape.

A support bar C-251 may protrude from the inner circumferential surface of the hub C-25 toward the third insertion hole C-254. The support bar C-251 may have a shape that is elongated in the upward-downward direction. The support bar C-251 may be provided in a plural number, and the plurality of support bars C-251 may be arranged so as to be spaced apart from each other in the circumferential direction along the inner circumferential surface of the hub C-25. For example, at least one pair of support bars C-251 may be provided, and the support bars C-251 forming each pair may be disposed opposite each other with respect to the third insertion hole C-254. A support guide C-252 may be formed at the lower end of each of the support bars C-251. The support guide C-252 may be formed to be rounded upwards from the lower end of each of the support bars C-251.

A first fixing hole C-221 may be formed in such a manner that a portion of the second plate C-22 is open. The first fixing hole C-221 may be formed adjacent to the edge of the second plate C-22. The first fixing hole C-221 may communicate with the space C-234. The first fixing hole C-221 may be disposed between the space C-234 and a second fixing hole C-222. The first fixing hole C-221 may be spaced apart from the second insertion hole C-224.

The first fixing hole C-221 may be formed in a pair. The second insertion hole C-224 may be disposed between the pair of first fixing holes C-221. The pair of first fixing holes C-221 may be disposed opposite each other with respect to the second insertion hole C-224. The pair of fixing holes C-221 and the second insertion hole C-224 may be disposed in one straight line. The pair of first fixing holes C-221 and the second insertion hole C-224 may be disposed in one straight line in the direction in which the inner spacer C-231 extends. Each of the pair of first fixing holes C-221 may be disposed between an end of one of a pair of ribs C-261 and an end of the other of the pair of ribs C-261.

The second fixing hole C-222 may be formed in such a manner that a portion of the second plate C-22 is open. The second fixing hole C-222 may be located under the first fixing hole C-221. The second fixing hole C-222 may communicate with the first fixing hole C-221. The second fixing hole C-222 may be spaced apart from the space C-234 in the downward direction. The circumference of the second fixing hole C-222 may be larger than the circumference of the first fixing hole C-221. The center of the second fixing hole C-222 and the center of the first fixing hole C-221 may be aligned with each other. The edge of the second fixing hole C-222 may be disposed further outwards than the edge of the first fixing hole C-221. The second fixing hole C-222 may be formed to be recessed further outwards than the first fixing hole C-221. The second fixing hole C-222 may be formed in a pair. Each of the pair of second fixing holes C-222 may be connected to a respective one of the pair of first fixing holes C-221.

The first cover C-20 may include a rib C-261. The rib C-261 may be disposed beneath the second plate C-22. The rib C-261 may extend downwards from the second plate C-22. The rib C-261 may be disposed adjacent to the edge of the second plate C-22. The rib C-261 may extend along the circumference of the second plate C-22. The rib C-261 may extend in the circumferential direction about the third insertion hole C-254. The rib C-261 may be recessed from the circumference of the second plate C-22 in the radially inward direction.

The rib C-261 may be provided in a pair. The pair of ribs C-261 may be disposed opposite each other with respect to the third insertion hole C-254. Each of the pair of ribs C-261 may be disposed below a respective one of the pair of spacers C-23. Each of the pair of ribs C-261 may be disposed at a position corresponding to a respective one of the pair of spacers C-23. The first fixing hole C-221 and the second fixing hole C-222 may be disposed between an end of one of the pair of ribs C-261 and an end of the other of the pair of ribs C-261, which are adjacent to each other. The ribs C-261 may support the second plate C-22. The ribs C-261 may provide the second plate C-22 with force resistant to deformation.

A positioning portion C-262 may be formed in such a manner that an end of the rib C-261 is inclined. The positioning portion C-262 may be inclined from the lower side of the rib C-261 toward the upper side thereof in the outward direction of the rib C-261. When the first cover C-20 is inserted into a mold, the positioning portion C-262 may guide the first cover C-20 to the correct position, whereby the first cover C-20 may be easily inserted into the mold.

The first cover C-20 may include a connector C-263. The connector C-263 may interconnect the hub C-25 and the rib C-261. The connector C-263 may extend from the hub C-25 to the rib C-261. The connector C-263 may be provided in a plural number. The plurality of connectors C-263 may be radially arranged about the hub C-25. For example, four connectors C-263 may be provided. The first fixing hole C-221 and the second fixing hole C-222 may be disposed between two adjacent ones of the connectors C-263 so as to be adjacent thereto. The screw hole C-27 may be disposed between two adjacent ones of the connectors C-263 so as to be adjacent thereto. The connectors C-263 may be integrally formed with the second plate C-22. The connectors C-263 may provide the second plate C-22 with force resistant to deformation.

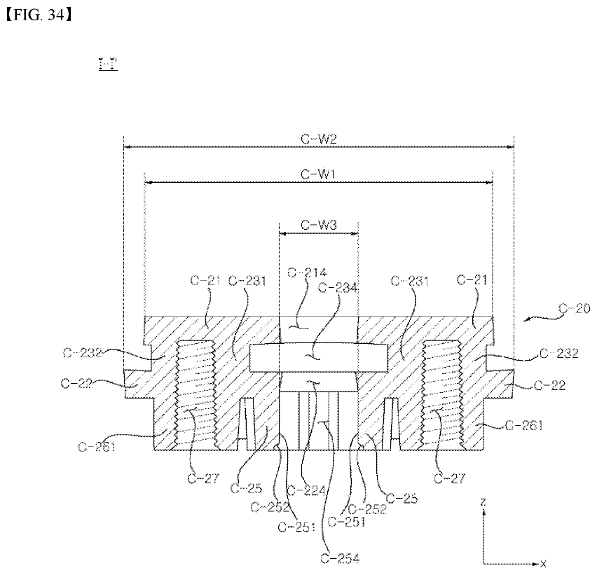

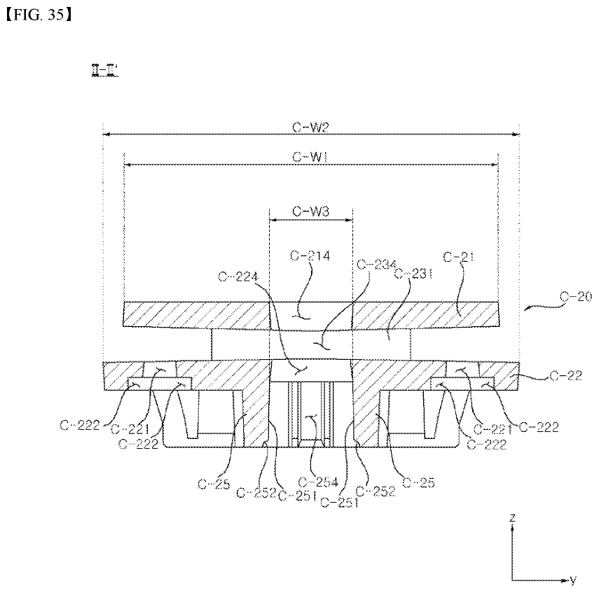

Referring to FIGS. 34 and 35, the width C-w1 of the first plate C-21 may be smaller than the width C-w2 of the second plate C-22. The edge of the first plate C-21 may be disposed further inwards than the edge of the second plate C-22.

The first insertion hole C-214, the second insertion hole C-224, and the third insertion hole C-254 may be disposed parallel to each other in the upward-downward direction. The first insertion hole C-214, the second insertion hole C-224, and the third insertion hole C-254 may overlap each other in the upward-downward direction. The diameter C-w3 of the first insertion hole C-214 and the diameter C-w3 of the second insertion hole C-224 may be equal to each other.

The first plate C-21 and the second plate C-22 may cover the upper and lower portions of the space C-234. The space C-234 may be larger than the first insertion hole C-214 and the second insertion hole C-224. A portion of the space C-234 may be formed between the first insertion hole C-214 and the second insertion hole C-224. The first insertion hole C-214 and the second insertion hole C-224 may communicate with the space C-234. The space C-234 may be open in the direction in which the inner spacer C-231 extends. The space C-234 may be open toward the first fixing hole C-221 and the second fixing hole C-222.

The pair of first fixing holes C-221 may be disposed in the direction in which the inner spacer C-231 is elongated, and may be formed adjacent to respective ends of the inner spacer C-231. The first fixing holes C-221 may be disposed in the direction in which the space C-234 is open. The first fixing holes C-221 may communicate with the space C-234. The first fixing holes C-221 may be disposed below the space C-234. The second fixing hole C-222 may be larger than the first fixing hole C-221. The second fixing hole C-222 may overlap the first fixing hole C-221 in the upward-downward direction. The edge of the second fixing hole C-222 may be disposed further outwards than the edge of the first fixing hole C-221.

The screw hole C-27 may be formed through the outer spacer C-232 from beneath the second plate C-22. The screw hole C-27 may be open downwards. The screw hole C-27 may have a thread formed therein.

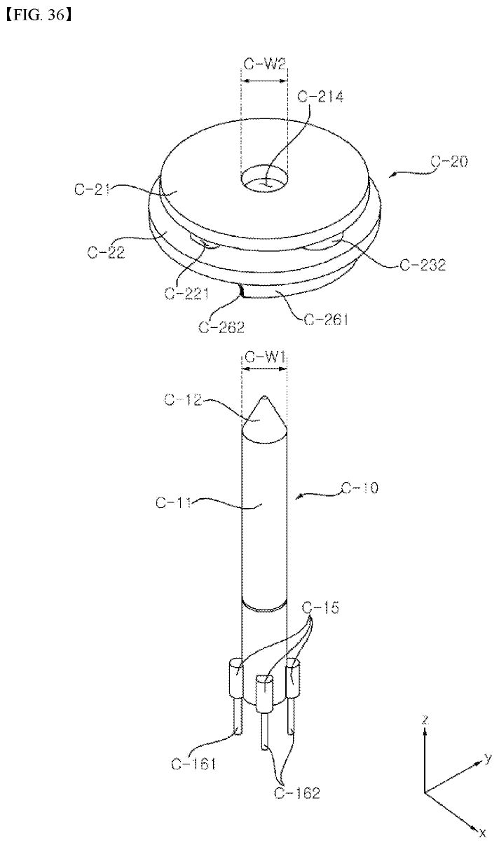

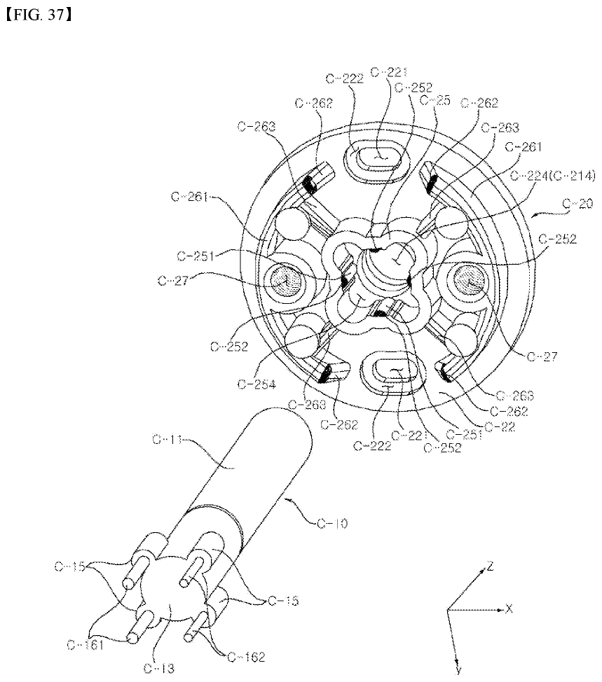

Referring to FIGS. 36 and 37, a heater C-10 may be formed to be elongated in one direction. The heater C-10 may have a cylindrical shape. The heater C-10 may be pointed at one end. The heater C-10 may be heated by directly receiving power, or may be heated by an induction-heating method using an induction coil disposed near the heater. The heater C-10 may penetrate the first cover C-20. The heater C-10 may be inserted into the first insertion hole C-214, the second insertion hole C-224, and the third insertion hole C-254.

The heater C-10 may include a heater body C-11. The heater body C-11 may be elongated in the upward-downward direction. The heater body C-11 may have a cylindrical shape. The heater C-10 may include a heater tip C-12. The heater tip C-12 may be formed at one end of the heater C-10. The heater tip C-12 may be connected to the upper end of the heater body C-11. The heater tip C-12 may have a shape that is gradually narrowed in the upward direction. The heater tip C-12 may be pointed at one end. The heater C-10 may pierce a cigarette.

A fixing portion C-15 may be formed on the periphery of the lower end portion of the heater C-10. The fixing portion C-15 may protrude in the radially outward direction from the outer circumferential surface of the lower end portion of the heater C-10. The fixing portion C-15 may be formed in the shape of a cylinder that extends in the upward-downward direction. The fixing portion C-15 may be provided in a plural number, and the plurality of fixing portions C-15 may be arranged in the circumferential direction along the outer circumferential surface of the lower end portion of the heater. One of the fixing portions C-15 may surround and fix a first lead wire C-161. The other of the fixing portions C-15 may surround and fix a second lead wire C-162. The number of fixing portions C-15 may correspond to the number of first and second lead wires C-161 and C-162. For example, when two first lead wires C-161 and two second lead wires C-162 are provided, the number of fixing portions C-15 may be four.

The first lead wire C-161 may be exposed downwards from a portion peripheral to the lower end portion of the heater C-10. The first lead wire C-161 may penetrate the fixing portion C-15. The first lead wire C-161 may be electrically connected to the heater C-10 to transmit power to the heater C-10. The heater C-10 may generate heat using the power received from the first lead wire C-161. The first lead wire C-161 may be provided in a pair.

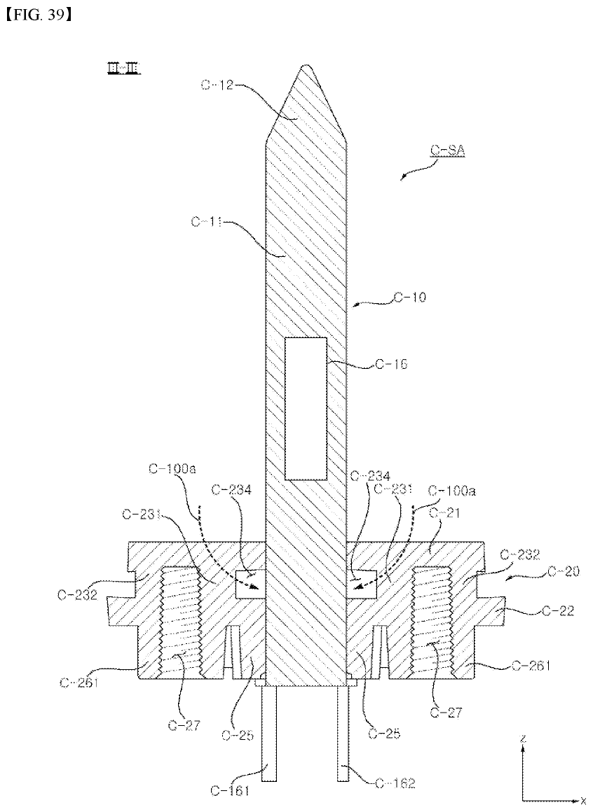

The second lead wire C-162 may be exposed downwards from a portion peripheral to the lower end portion of the heater C-10. The second lead wire C-162 may penetrate the fixing portion C-15. The heater C-10 may be formed to be hollow. A sensor C-16 (refer to FIG. 39) may be mounted inside the heater C-10. The sensor C-16 may sense the temperature of the heater C-10. The second lead wire C-162 may be electrically connected to the sensor C-16 to transmit power to the sensor C-16. The second lead wire C-162 may be provided in a pair. The first lead wire C-161 and the second lead wire C-162 may be disposed opposite each other with respect to the lower end portion of the heater. The first lead wire C-161 and the second lead wire C-162 may have mutually different thicknesses.

The width C-w4 of the heater body C-11 may be equal to or slightly greater than the width C-w3 of the first insertion hole C-214. The width C-w4 of the heater body C-11 may be equal to or slightly greater than the width C-w3 of the second insertion hole C-224.

Referring to FIGS. 36 to 38, the heater C-10 may be inserted into all of the first insertion hole C-214, the second insertion hole C-224, and the third insertion hole C-254. The heater C-10 may pass through the first to third insertion holes C-214, C-224, and C-254 sequentially from the heater tip C-12 (refer to FIG. 31) to the heater body C-11. The heater C-10 may be inserted into the first cover C-20 from below to above. The heater C-10 may be inserted into the third insertion hole C-254, the second insertion hole C-224, and the first insertion hole C-214 in that order.

The width C-w4 of the heater body C-11 may be equal to or slightly greater than the width C-w3 of the first insertion hole C-214 and the width C-w3 of the second insertion hole C-224. The heater C-10 may be tightly press-fitted into the first insertion hole C-214 and the second insertion hole C-224. The heater C-10 may be exposed to the outside through the first insertion hole C-214 and the second insertion hole C-224. The upper portion of the heater C-10 may be exposed upwards from the first cover C-20. The heater body C-11 and the heater tip C-12 may be exposed upwards from the first cover C-20. The lower end portion C-13 of the heater C-10 may be exposed downwards from the first cover C-20.

The heater C-10 may pass through the third insertion hole C-254, and may then be inserted into the first insertion hole C-214 and the second insertion hole C-224. When the heater C-10 passes through the third insertion hole C-254, the support guide C-252 may guide the heater C-10 to the third insertion hole C-254. The heater C-10 may slide toward the third insertion hole C-254 and the second insertion hole C-224 while contacting the support guide C-252.

The support bar C-251 may be elongated in the direction in which the heater C-10 moves toward the second insertion hole C-224 through the third insertion hole C-254. The support bar C-251 may be elongated in the direction in which the second insertion hole C-224 and the first insertion hole C-214 are disposed parallel to each other. The heater body C-11 may slide toward the second insertion hole C-224 while contacting the support bar C-251 in the third insertion hole C-254. The support bar C-251 may support the circumference of the heater body C-11. The support bar C-251 may enable the heater body C-11 to be oriented in the direction in which the second insertion hole C-224 and the first insertion hole C-214 are disposed parallel to each other.

When the heater C-10 is inserted into the first insertion hole C-214 and the second insertion hole C-224, the fixing portion C-15 may be disposed in the third insertion hole C-254. The hub C-25 and the third insertion hole C-254 may have shapes corresponding to the lower end portion C-13 of the heater C-10 and the fixing portion C-15. The lower end portion C-13 of the heater C-10 and the fixing portion C-15 may be surrounded by the hub C-25 in the third insertion hole C-254. The lower end portion C-13 of the heater C-10 and the fixing portion C-15 may be open downwards. When the heater C-10 rotates in the circumferential direction, the fixing portion C-15 may be caught by the hub C-25. The first lead wire C-161 and the second lead wire C-162 may be exposed downwards from the hub C-25.

Accordingly, it may be easy to insert the heater C-10 so as to sequentially pass through the second insertion hole C-224 and the first insertion hole C-214. In addition, it is possible to prevent the heater C-10 from shaking. In addition, it is possible to prevent the heater C-10 from rotating in the circumferential direction. In addition, it is possible to prevent the first lead wire C-161 and the second lead wire C-162 from becoming twisted with each other or becoming disconnected.

Hereinafter, a structure in which the heater C-10 and the first cover C-20 are coupled may also be referred to as a heater assembly C-HA.

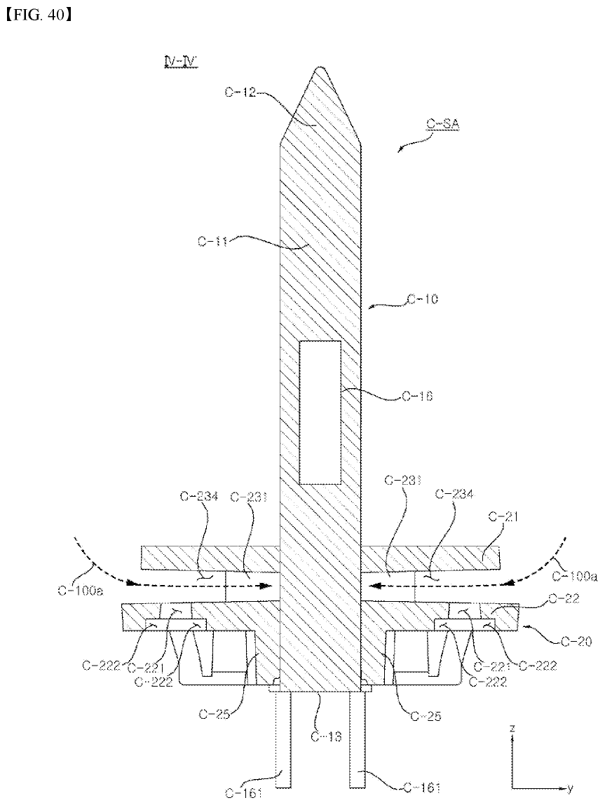

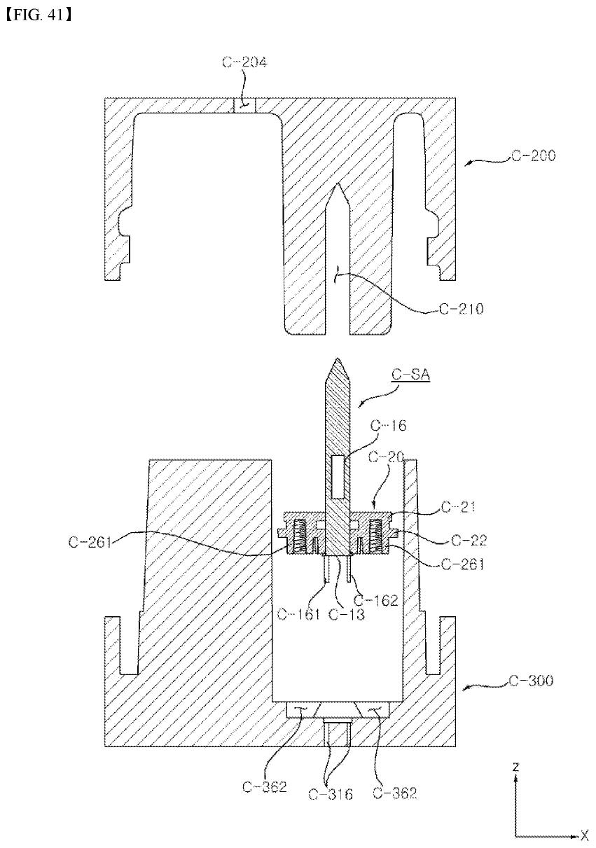

Referring to FIGS. 39 and 40, the sensor C-16 may sense the temperature of the heater C-10. The sensor C-16 may be mounted inside the heater C-10. The heater C-10 may be formed to be hollow, and the sensor C-16 may be inserted into the heater C-10. The sensor C-16 may be formed to be elongated in one direction, and may be disposed in the longitudinal direction of the heater body C-11. The sensor C-16 may be electrically connected to the second lead wire C-162 to receive power. The heater C-10 may be electrically connected to the first lead wire C-161 to receive power.

When the heater C-10 is coupled to the first cover C-20, the upper portion of the heater C-10 may be exposed upwards from the first plate C-21. The upper portion of the heater C-10 may be elongated upwards from the first plate C-21.

The heater C-10 may penetrate the space C-234. A portion of the heater C-10 may be disposed in the space C-234. The space C-234 may be in contact with one side of the heater body C-11. The space C-234 may be exposed outside the first cover C-20. A portion of the heater body C-11 may be exposed outside the first cover C-20 through the space C-234. The heater body C-11 may be disposed between the pair of inner spacers C-231.

The heater C-10 may be press-fitted into the first plate C-21 and the second plate C-22, and thus the position thereof relative to the first cover C-20 may be fixed. The first plate C-21 and the second plate C-22 may support the heater C-10 at two points in the upward-downward direction. The second plate C-22 and the hub C-25 may support the lower portion of the heater C-10. The first lead wire C-161 and the second lead wire C-162 may be exposed downwards from the first cover C-20.

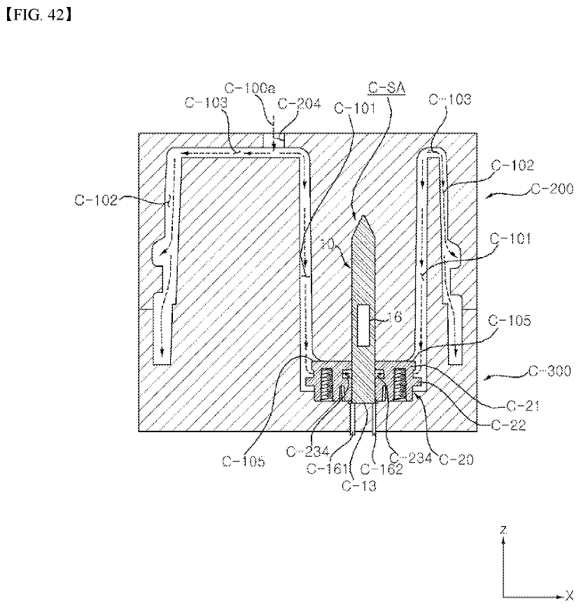

Referring to FIG. 41, the heater assembly C-HA may be inserted into a first mold C-200 and a second mold C-300. The upper portion of the heater assembly C-HA may be inserted into the first mold C-200. The lower portion of the heater assembly C-HA may be inserted into the second mold C-300. The first mold C-200 and the second mold C-300 may be coupled to each other in the upward-downward direction. The first mold C-200 and the second mold C-300 may be coupled to each other to form a space in which the heater assembly C-HA can be disposed.

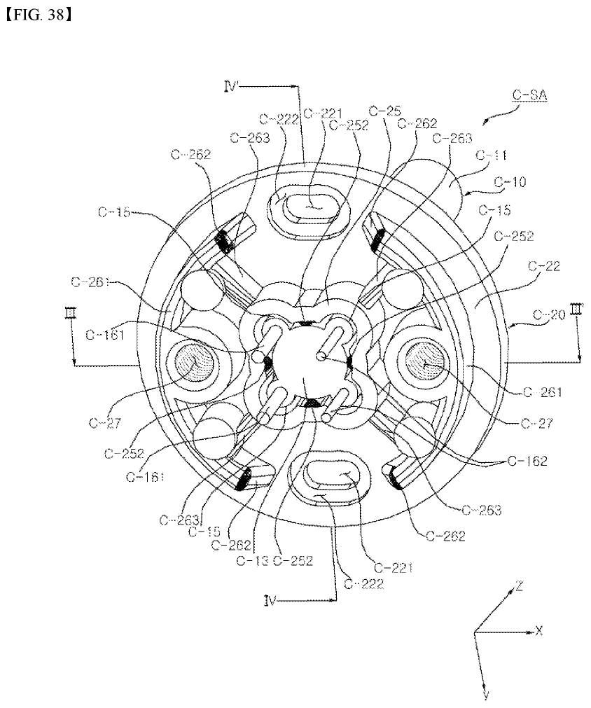

The second mold C-300 may include a mold recess C-362. The rib C-261 (refer to FIG. 38) may be inserted into the mold recess C-362. When the rib C-261 is inserted into the mold recess C-362, the position of the heater assembly C-HA may be fixed inside the second mold C-300.

The positioning portion C-262 (refer to FIG. 38) may be in contact with the second mold C-300 at a position near the mold recess C-362. The mold recess C-362 may be inclined so as to correspond to the positioning portion C-262. When the rib C-261 is inserted into the mold recess C-362, the positioning portion C-262 may slide while contacting the second mold C-300, thereby guiding the heater assembly C-HA to the correct position in the second mold C-300.

Accordingly, the heater assembly C-HA may be easily inserted into or disposed in the second mold C-200. In addition, the first lead wire C-161 and the second lead wire C-162 may be prevented from contacting each other, becoming twisted with each other, or becoming disconnected.

The heater body C-11 may be inserted into or supported by the first mold C-200. The first mold C-200 may have a heater hole C-210 formed therein. The heater body C-11 may be inserted into or pass through the heater hole C-210. The upper portion of the first cover A-20 may be supported by the first mold C-200. The lower portion of the first cover C-20 may be supported by the second mold C-300. The lower end portion C-13 of the heater C-10 may be supported by the second mold C-300.

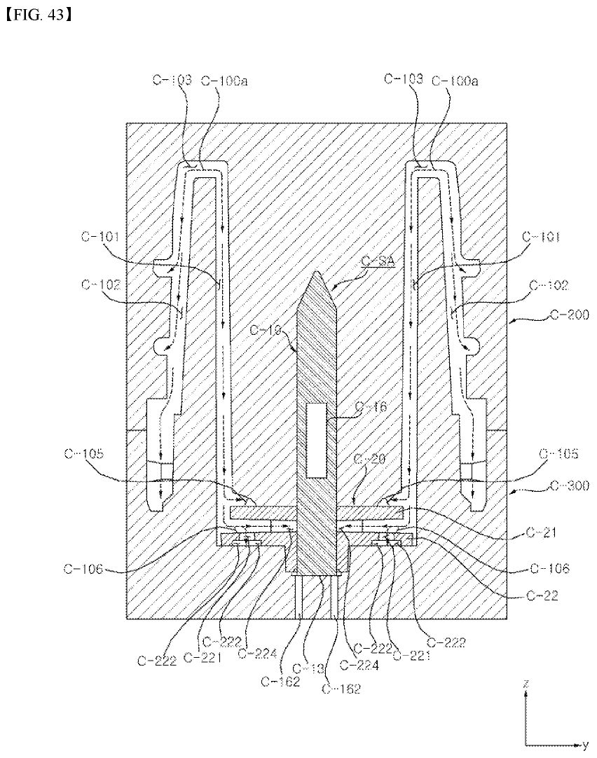

Referring to FIGS. 42 and 43, when the first mold C-200 and the second mold C-300 are brought into contact with or coupled to each other, passages C-101, C-102, and C-103 may be formed between the first mold C-200 and the second mold C-300. The passages C-101, C-102, and C-103 may be connected to the heater assembly C-HA. The passages C-101, C-102, and C-103 may be connected to the space C-234.

The first passage C-101 may be formed between the first mold C-200 and the second mold C-300. The first passage C-101 may be formed to be elongated in the upward-downward direction. The first passage C-101 may have a cylindrical shape. The heater assembly C-HA may be disposed in the lower portion of the first passage C-101. The lower portion of the first passage C-101 may surround the side peripheral portion of the first cover C-20.

The lower portion of the first passage C-101 may be in contact with and surround the circumference of the first plate C-21. The lower portion of the first passage C-101 may be in contact with and surround the circumference of the second plate C-22. The first passage C-101 may communicate with the space C-234.

The first passage C-101 may communicate with a latching groove C-105. The latching groove C-105 may extend along the edge of the upper end of the first plate C-21. The latching groove C-105 may extend in the circumferential direction. The latching groove C-105 may be in contact with the edge of the upper end of the first cover C-20.

The first passage C-101 may communicate with an inlet groove C-106. The inlet groove C-106 may be disposed between the first plate C-21 and the second plate C-22. The inlet groove C-106 may communicate with the space C-234. The inlet groove C-106 may extend from the edges of the first plate C-21 and the second plate C-22 to the region between the pair of spacers C-23.

The second passage C-102 may extend from the upper end of the first passage C-101 in the outward direction. The third passage C-103 may extend downwards from an end of the second passage C-102. The third passage C-103 may be spaced apart from the first passage C-101. The third passage C-103 may surround the side portion of the first passage C-101.

At least one of the first mold C-200 or the second mold C-300 may include a molding material injection hole C-204. The molding material injection hole C-204 may communicate with the passages C-101, C-102, and C-103. For example, the molding material injection hole C-204 may communicate with the second passage C-102.

The first mold C-200 and the second mold C-300 described above are merely illustrative. The disclosure is not limited to any specific number, shape, or coupling direction of molds, so long as the molds form a space in which the heater assembly C-HA can be inserted or disposed and also form the passages C-101, C-102, and C-103.

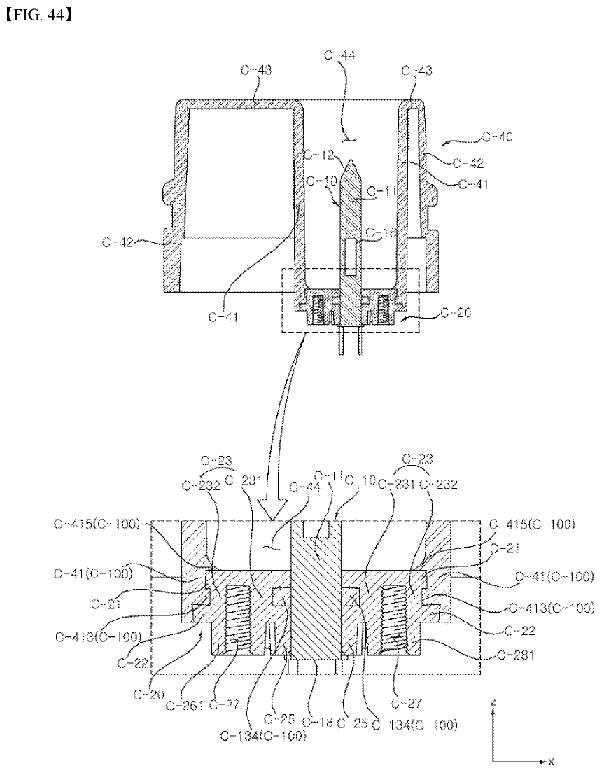

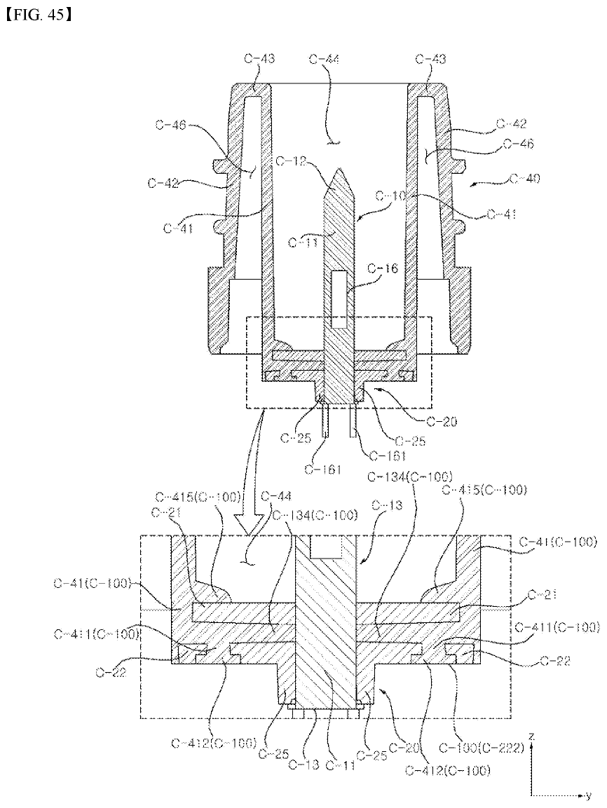

Referring to FIGS. 42 to 45, a housing C-40 may be formed through insert injection molding using the molds C-200 and C-300. A sealing member C-134 may be insert-injection-molded into the space C-234 in the heater assembly C-HA. The sealing member C-134 may be insert-injection-molded into the gaps between the components of the heater assembly C-HA. The heater assembly C-HA and the housing C-40 may be coupled to each other through insert injection molding. The housing C-40 may be integrally connected to the sealing member C-134, which is insert-injection-molded into the heater assembly C-HA.

The first molding material C-100a may be injected into the molds C-200 and C-300 through the molding material injection hole C-204. The first molding material C-100a may be injected into the molding material injection hole C-204, and may then be introduced into the passages C-101, C-102, and C-103. The first molding material C-100a may be in a molten state. The passages C-101, C-102, and C-103 may be filled with the first molding material C-100a. The first molding material C-100a may be introduced into the space C-234 from the first passage C-101. The first molding material C-100a introduced into the space C-234 may fill the gaps between the components of the heater assembly C-HA. The first molding material C-100a in a molten state may be cured into a second molding material C-100.

The first molding material C-100a injected into the passages C-101, C-102, and C-103 in the molds C-200 and C-300 may be cured to form the second molding material C-100, thereby forming the housing C-40. The first molding material C-100a introduced into the space C-234 may be cured while filling the gaps between the components of the heater assembly C-HA, thereby forming the second molding material C-100. The second molding material C-100, which is insert-injection-molded into the gaps between the components of the heater assembly C-HA in the space C-234 and/or in the vicinity of the space C-234, may also be referred to as a sealing member C-134.

The sealing member C-134 may be formed of the second molding material C-100. The sealing member C-134 may be insert-injection-molded into the space C-234. The sealing member C-134 may fill the space C-234. The sealing member C-134 may completely fill the space C-234, thereby fixing the space C-234 and the periphery of the space C-234 and sealing the same. The sealing member C-134 may be insert-injection-molded between the first insertion hole C-214 (refer to FIG. 34) and the heater body C-11. The sealing member C-134 may be insert-injection-molded between the second insertion hole C-224 (refer to FIG. 34) and the heater body C-11.

The sealing member C-134 may be insert-injection-molded between the pair of spacers C-23. The sealing member C-134 may include a portion that is elongated between the pair of spacers C-23 in the direction in which the spacers C-23 extend. The sealing member C-134 may be elongated between the pair of spacers C-23, and may be integrally connected at an end thereof to the inner circumferential surface of the pipe C-41.

The housing C-40 may be formed through insert injection molding, and may be formed of the second molding material C-100. The housing C-40 may include a pipe C-41. The housing C-40 may include an outer wall C-42. The housing C-40 may include an upper wall C-43. The housing C-40 may include a latching portion C-415.

The pipe C-41 may be formed of the second molding material C-100, formed by curing the first molding material C-100a introduced into the first passage C-101. The pipe C-41 may have a cylindrical shape. The pipe C-41 may have formed therein an insertion space C-44 having two open opposite sides. The insertion space C-44 may have a cylindrical shape. The insertion space C-44 may be formed to be elongated in the upward-downward direction. The upper side of the insertion space C-44 may communicate with the outside. The lower side of the insertion space C-44 may be covered by the first cover C-20.

The pipe C-41 may be coupled to the heater assembly C-HA through insert injection molding. The first plate C-21 may block the lower portion of the pipe C-41. The first plate C-21 may separate the insertion space C-44 and the space C-234 from each other.

The pipe C-41 may be integrally connected to the sealing member C-134 insert-injection-molded into the space C-234. The pipe C-41 may be integrally connected to the sealing member C-134 through the portion of the space C-234 that is open outwards from the cover C-20.

The heater body C-11 and the heater tip C-12 may be disposed in the insertion space C-44. A cigarette may be inserted into the insertion space C-44, and the heater C-10 may penetrate the lower portion of the cigarette. The heater C-10 may be operated to heat the cigarette. The lower end portion C-13 of the heater C-10, the first lead wire C-161, and the second lead wire C-162 may be exposed downwards from the pipe C-41.

The spacer C-23 may be recessed inwards from the edge of the first plate C-21 and the edge of the second plate C-22. The sealing member C-134 may be insert-injection-molded between the edge of the first plate C-21 and the edge of the second plate C-22 outside the spacer C-23, and may be integrally connected to the inner circumferential surface of the pipe C-41.

The latching portion C-415 may be formed of the second molding material C-100, formed by curing the first molding material C-100a introduced into the latching groove C-105. The latching portion C-415 may be integrally formed with the pipe C-41. The latching portion C-415 may protrude from the inner circumferential surface of the pipe C-41 in the radially inward direction. The latching portion C-415 may cover and support the upper edge of the first plate C-21. The latching portion C-415 may extend in the circumferential direction along the upper edge of the first plate C-21. The latching portion C-415 may prevent upward movement of the heater assembly C-HA.

The first plate C-21 may be disposed between the latching portion C-415 and the sealing member C-134. The latching portion C-415 and the sealing member C-134 may fix the first plate C-21 in the upward-downward direction. The latching portion C-415 may provide the first plate C-21 with force resistant to deformation. The sealing member C-134 may provide the first plate C-21 with force resistant to deformation. The sealing member C-134 may provide the second plate C-22 with force resistant to deformation.

The upper wall C-43 may extend outwards from the upper end of the pipe C-41. The upper wall C-43 may be formed of the second molding material C-100, formed by curing the first molding material C-100a introduced into the second passage C-102. The upper wall C-43 may form the upper portion of the housing C-40.

The outer wall C-42 may extend downwards from an end of the upper wall C-43. The outer wall C-42 may be formed of the second molding material C-100, formed by curing the first molding material C-100a introduced into the third passage C-103. The outer wall C-42 may form the outer side surface of the housing C-40. The outer wall C-42 may be spaced apart from the pipe C-41 in the outward direction. A space C-46 may be formed between the pipe C-41 and the outer wall C-42.

Fixing members C-411 and C-412 may be insert-injection-molded into the fixing holes C-221 and C-222. The fixing members C-411 and C-412 may fill the fixing holes C-221 and C-222. The fixing members C-411 and C-412 may be integrally connected to the sealing member C-134. The fixing members C-411 and C-412 may provide the second plate C-22 with force resistant to deformation. The fixing members C-411 and C-412 may be widened in the downward direction.

The first molding material C-100a may be introduced into the first fixing hole C-221. The first molding material C-100a introduced into the first fixing hole C-221 may be cured to form the second molding material C-100. The portion of the second molding material C-100 that is insert-injection-molded into the first fixing hole C-221 may also be referred to as a first fixing member C-411. The first fixing member C-411 may completely fill the first fixing hole C-221 to seal the same. The first fixing member C-411 may be integrally connected to the sealing member C-134.

The first molding material C-100a may be introduced into the second fixing hole C-222. The first molding material C-100a introduced into the second fixing hole C-222 may be cured to form the second molding material C-100. The portion of the second molding material C-100 that is insert-injection-molded into the second fixing hole C-222 may also be referred to as a second fixing member C-412. The second fixing member C-412 may completely fill the second fixing hole C-222 to seal the same. The first fixing member C-411 and the second fixing member C-412 may be integrally connected to each other.

The second fixing member C-412 may be caught by the periphery of the edge of the second plate C-22. The second fixing member C-412 may fix the periphery of the edge of the second plate C-22. The second fixing member C-412 may provide the second plate C-22 with force resistant to deformation. The second fixing member C-412 may prevent the periphery of the edge of the second plate C-22 from being thermally deformed downwards.

Accordingly, the gaps between the components of the heater assembly C-HA may be completely filled. In addition, the gap between the housing C-40 and the heater assembly C-HA may be completely filled. In addition, it is possible to prevent foreign substances, such as liquid, from leaking through the gap around the heater C-10.

In addition, the heater assembly C-HA may be stably fixed to or supported by the housing C-40. In addition, the heater assembly C-HA may be prevented from being thermally deformed when insert injection molding is performed or when the heater C-10 generates heat. In addition, the first lead wire C-161 and the second lead wire C-162 may be prevented from becoming twisted with each other or becoming disconnected.

In addition, the process of assembling the heater assembly C-HA may be further simplified. In addition, the process of coupling the heater assembly C-HA and the housing C-40 to each other may be further simplified.

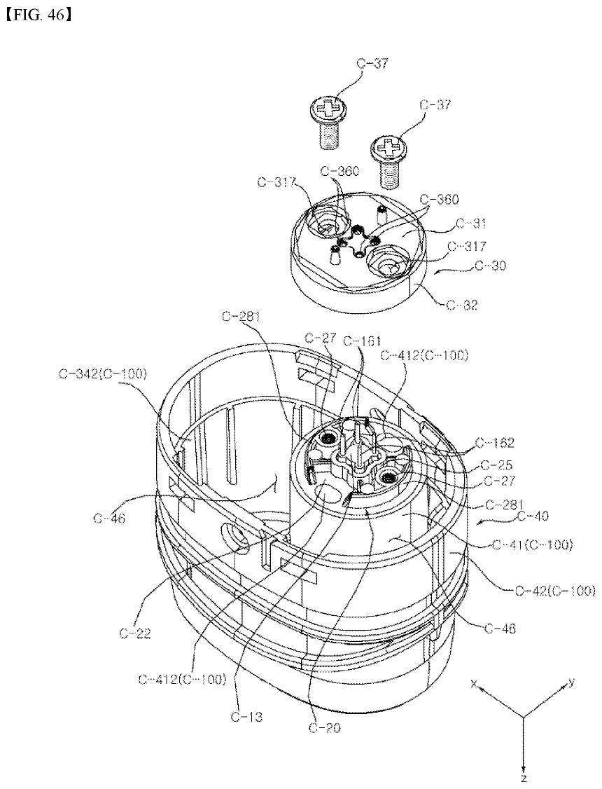

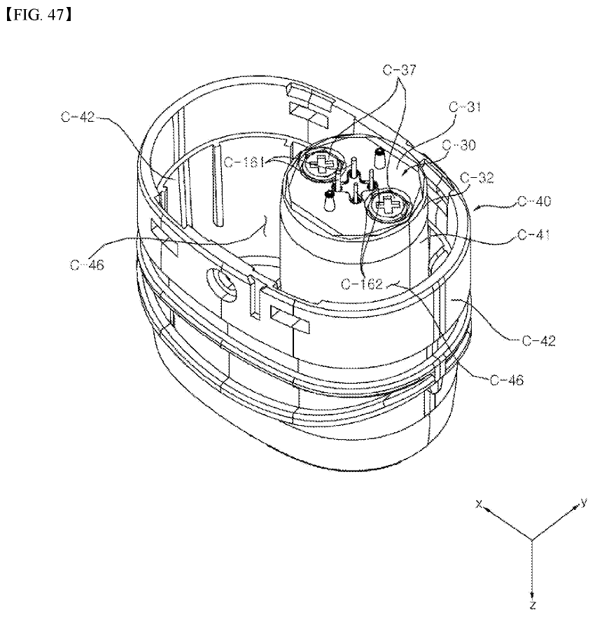

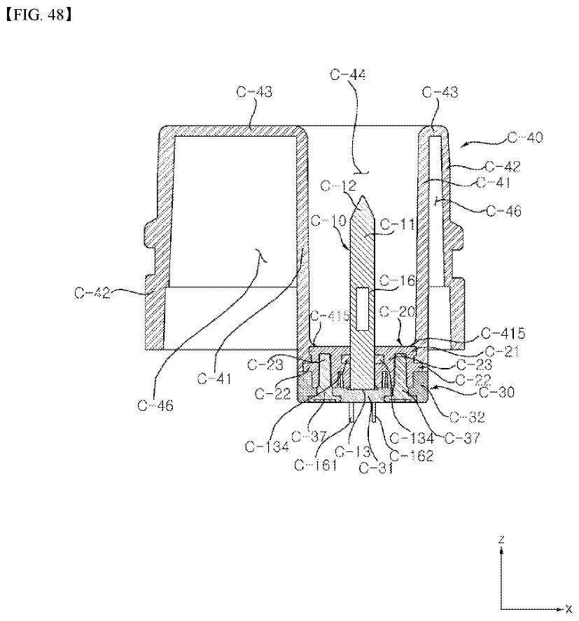

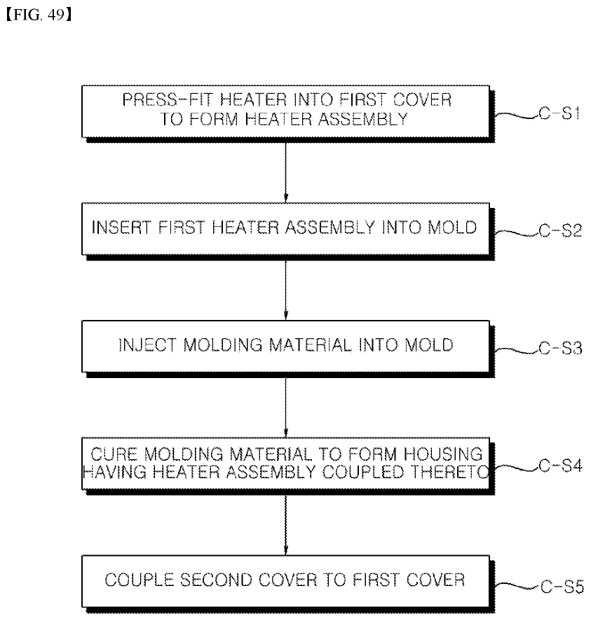

Referring to FIGS. 46 to 48, the second cover C-30 may be coupled to the first cover C-20 while covering the lower portion of the first cover C-20. The second cover C-30 may be screwed to the lower portion of the first cover C-20. The second cover C-30 may support the lower portion of the first cover C-20 while contacting the same. The second cover C-30 may support the lower end portion C-13 of the heater C-10 while covering the same. The second cover C-30 may support the rib C-261 while covering the same. The first cover C-20 may also be referred to as an inner cover C-20 or an upper cover C-20. The second cover C-30 may also be referred to as an outer cover C-30, a lower cover C-30, or a support cover C-30.

The second cover C-30 may include a cover bottom portion C-31 and a cover peripheral portion C-32. The cover bottom portion C-31 may have a disk shape. The cover bottom portion C-31 may cover the lower portion of the first cover C-20 from beneath. The cover bottom portion C-31 may support the lower end portion C-13 or the bottom portion C-13 of the heater C-10. The cover bottom portion C-31 may support the lower end of the rib C-261.

A fastening hole C-317 may be formed in such a manner that a portion of the cover bottom portion C-31 is open in the upward-downward direction. The fastening hole C-317 may be formed in a plural number. The fastening hole C-317 may be formed in a pair, and each of the pair of fastening holes C-317 may be formed at a position corresponding to a respective one of the pair of screw holes C-27. Screws C-37 may be fastened into the screw holes C-27 through the fastening holes C-317. The cover bottom portion C-31 may be fixed to the lower side of the first cover C-20 by means of the screws C-37.

Wire holes C-360 may be formed in such a manner that some portions of the cover bottom portion C-31 are open. The wire holes C-360 may be formed in the center of the cover bottom portion C-31. The number of wire holes C-360 may correspond to the number of first and second lead wires C-161 and C-162. Each of the pair of first lead wires C-161 may be inserted into a corresponding one of the plurality of wire holes C-360, and each of the pair of second lead wires C-162 may be inserted into a corresponding one of the plurality of wire holes C-360. The lead wires C-161 and C-162 may pass through the wire holes C-360, and may be exposed outside the second cover C-30.

The cover peripheral portion C-32 may extend upwards from the edge of the cover bottom portion C-31. The cover peripheral portion C-32 may extend in the circumferential direction along the circumference of the cover bottom portion C-31. When the second cover C-30 is coupled to the first cover C-20, the cover peripheral portion C-32 may cover the lower portion of the first cover C-20 in the circumferential direction. The cover peripheral portion C-32 may surround or support the side portion of the rib C-261.

Accordingly, it is possible to protect the lower portion of the first cover C-20 and the heater C-10, which are exposed downwards from the pipe C-41. In addition, it is possible to prevent the heater C-10 from being separated downwards by supporting or fixing the heater C-10. In addition, it is possible to prevent the first cover C-20 from being thermally deformed.

Referring to FIG. 49, the heater assembly C-HA may be formed by press-fitting the heater C-10 into the first cover C-20 (C-S1). Thereafter, the heater assembly C-HA may be inserted into the mold (C-S2). Thereafter, a molding material in a molten state may be injected into the mold having the heater assembly C-HA inserted thereinto (C-S3). Thereafter, the molding material may be cured, and the mold may be removed, whereby the housing C-40 to which the heater assembly C-HA is coupled may be formed (C-S4). Thereafter, the second cover C-30 may be coupled to the first cover C-20 (C-S5). A method of manufacturing the aerosol-generating device according to the present disclosure may include at least one of steps S1 to S5.

Referring to FIGS. 31 to 49, an aerosol-generating device in accordance with one aspect of the present disclosure may include a pipe C-41, a first plate C-21 partitioning an inside of the pipe C-41 to define an insertion space C-214, an elongated heater C-10 extending through the first plate C-21 such that one side of the heater is disposed in the insertion space C-44 and an opposite side of the heater is disposed in a sealing space C-234 positioned opposite the insertion space with respect to the first plate, and a sealing member C-134 charged in the sealing space C-234.

In addition, in accordance with another aspect of the present disclosure may include a first plate C-21, a second plate C-22 disposed so as to face the first plate C-21, a first insertion hole C-214 formed in the first plate C-21, a second insertion hole C-224 formed in the second plate C-22 so as to be aligned with the first insertion hole C-214, a spacer C-23 disposed between the first plate C-21 and the second plate C-22 to support the first plate C-21 and the second plate C-22, a space C-234 defined by the first plate C-21, the second plate C-22, and the spacer C-23 and communicating with the first insertion hole C-214 and the second insertion hole C-224, a heater C-10 elongated to pass through the first insertion hole C-214 and the second insertion hole C-224 so that one end thereof protrudes from the first plate C-21, and a sealing member C-134 charged in the space C-234.

In addition, in accordance with another aspect of the present disclosure, the space C-234 may be open to the outside between the first plate C-21 and the second plate C-22.

In addition, in accordance with another aspect of the present disclosure, the aerosol-generating device may further include a pipe C-41, which has formed therein an insertion space C-44 having an open side and an opposite side blocked by the first plate C-21 and is integrally formed with the sealing member C-134 through an opening in the space C-234.

In addition, in accordance with another aspect of the present disclosure, the spacer C-23 may be provided in a plural number, and the plurality of spacers C-23 may be disposed so as to be spaced apart from each other. The opening in the space C-234 may be formed between the plurality of spacers C-23.

In addition, in accordance with another aspect of the present disclosure, the spacer C-23 may be provided in a pair, and the pair of spacers C-23 may face each other, with the space C-234 interposed therebetween.

In addition, in accordance with another aspect of the present disclosure, the pair of spacers C-23 may be elongated in one direction, and the sealing member C-134 may include a portion that is elongated in one direction between the pair of spacers C-23 and is integrally formed with the pipe C-41.

In addition, in accordance with another aspect of the present disclosure, the aerosol-generating device may further include a latching portion C-415, which is integrally formed with the pipe C-41. The latching portion C-415 may protrude inwards from the inner circumferential surface of the pipe C-41 toward the insertion space C-44, and may extend along the circumference of the first plate C-21 to cover the upper edge of the first plate C-21.

In addition, in accordance with another aspect of the present disclosure, the spacer C-23 may be recessed inwards from the outer circumferential surface of the first plate C-21 and the outer circumferential surface of the second plate C-22, and the sealing member C-134 may include a portion that is charged between the edge of the first plate C-21 and the edge of the second plate C-22 outside the spacer C-23 and is integrally formed with the pipe C-41.

In addition, in accordance with another aspect of the present disclosure, the second plate C-22 may have fixing holes C-221 and C-222 formed to be open so as to communicate with two opposite sides of the space C-234, and the aerosol-generating device may further include fixing members C-411 and C-412 charged in the fixing holes C-221 and C-222 and integrally formed with the sealing member C-134.

In addition, in accordance with another aspect of the present disclosure, the fixing members C-411 and C-412 may be widened in the direction moving away from the sealing member C-134.

In addition, in accordance with another aspect of the present disclosure, the fixing members C-411 and C-412 may include a first fixing member C-411, which is integrally connected to the sealing member C-134, and a second fixing member C-412, which is spaced apart from the sealing member C-134 and has a larger width than the first fixing member C-411.

In addition, in accordance with another aspect of the present disclosure, the aerosol-generating device may further include a rib C-261, which protrudes downwards from the second plate C-22 and extends in one direction to support the second plate C-22.

In addition, in accordance with another aspect of the present disclosure, the rib C-261 may be provided in a plural number, and the plurality of ribs C-261 may be disposed opposite each other with respect to the second insertion hole C-224.

In addition, in accordance with another aspect of the present disclosure, the rib C-261 may extend in the circumferential direction along the circumference of the second plate C-22.

In addition, in accordance with another aspect of the present disclosure, the rib C-261 may be inserted into a recess formed in a mold during insert injection molding.

In addition, in accordance with another aspect of the present disclosure, the aerosol-generating device may further include a positioning portion C-262, which is formed at an end of the rib C-261 so as to be inclined and slides in the mold to be inserted thereinto to guide the first plate C-21, the second plate C-22, and the heater C-10 to the correct positions in the mold.

In addition, in accordance with another aspect of the present disclosure, the aerosol-generating device may further include a lower cover C-30, which is coupled to the lower side of the second plate C-22 and supports the lower end of the heater C-10.

In addition, in accordance with another aspect of the present disclosure, the aerosol-generating device may further include a pair of ribs C-261, which protrude downwards from the second plate C-22, extend along the circumference of the second plate C-22, and are disposed opposite each other with respect to the second insertion hole C-224. The lower cover C-30 may support the ribs C-261.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a pipe;
a first plate partitioning an inside of the pipe to define an insertion space;
an elongated heater extending through the first plate such that one side of the heater is disposed in the insertion space and an opposite side of the heater is disposed in a sealing space positioned opposite the insertion space with respect to the first plate; and
a sealing member charged in the sealing space.

2. The aerosol-generating device according to claim 1, wherein the sealing member is connected with the pipe.

3. The aerosol-generating device according to claim 1, further comprising:
a cover comprising the first plate and having the sealing space formed therein,
wherein the cover is coupled to the pipe.

4. The aerosol-generating device according to claim 3, wherein the cover comprises an open lateral side leading to the sealing space and at least one inlet hole formed at the open lateral side to allow the sealing member and the pipe to be connected to each other therethrough.

5. The aerosol-generating device according to claim 4, wherein the cover comprises:
a first cover comprising the first plate comprising a heater insertion hole through which the heater passes, wherein a lower portion of the first cover defines an upper side of the sealing space; and
a second cover coupled to the first cover, wherein an upper portion thereof defines a lower side of the sealing space.

6. The aerosol-generating device according to claim 5, wherein the first cover comprises a first peripheral portion extending downward from the first plate to define at least part of a side portion of the sealing space.

7. The aerosol-generating device according to claim 6, wherein the first cover comprises a support bar protruding inwardly from the first peripheral portion toward the sealing space to support a side portion of the heater and to separate the heater from the first peripheral portion to form a gap in the sealing space, and
wherein the sealing member is charged in the gap formed in the sealing space to fix the heater.

8. The aerosol-generating device according to claim 7, wherein an inclined support guide portion is formed at an end of the support bar to guide the heater into the heater insertion hole.

9. The aerosol-generating device according to claim 7, wherein the support bar is one of a plurality of support bars arranged to be spaced apart from each other along an inner circumference of the first peripheral portion, and
wherein the aerosol-generating device further comprises:
a non-circular flange protruding outwards from the heater and supported by the plurality of support bars.

10. The aerosol-generating device according to claim 5, wherein the second cover comprises:
a second plate defining the lower side of the sealing space and configured to support the heater; and
a second peripheral portion extending upward from the second plate to define a side portion of the sealing space.

11. The aerosol-generating device according to claim 10, wherein the at least one inlet hole is formed at the second peripheral portion.

12. The aerosol-generating device according to claim 5, further comprising:
a hook hole formed in the second cover; and
a hook protruding from the first cover and configured to engage with the hook hole to couple the first cover with the second cover,
wherein a gap is formed between the hook hole and the hook engaged with the hook hole and the sealing member and the pipe are connected to each other therethrough.

13. The aerosol-generating device according to claim 3, wherein the pipe comprises a latching portion protruding inwards from an inner circumferential surface of the pipe toward the insertion space, and
wherein the latching portion covers an upper edge of the cover.

14. The aerosol-generating device according to claim 3, wherein the cover comprises a positioning protrusion protruding downwards, and
wherein the positioning protrusion is configured to engage with a recess formed in an injection mold to guide the cover to a correct position in the mold,
wherein the positioning protrusion is one of a plurality of positioning protrusions each having different shapes.
wherein the positioning protrusion is tapered.

15. The aerosol-generating device according to claim 3, wherein the cover comprises a positioning recess at a lower portion of the cover configured to engage with a protrusion formed in an injection mold to guide the cover to a correct position in the mold.
